(19) United States
(12) Patent Application Publication
(10) Pub. No.: US 2024/0340839 A1
(43) Pub. Date: Oct. 10, 2024

(54) User Equipment Positioning in RRC INACTIVE and RRC IDLE States

(71) Applicant: Fraunhofer-Gesellschaft zur Förderung der angewandten Forschung e.V., München (DE)

(72) Inventors: Birendra GHIMIRE, Erlangen (DE); Mohammad Alawieh, Erlangen (DE); Ernst Eberlein, Erlangen (DE); Norbert Franke, Erlangen (DE)

(21) Appl. No.: 18/400,430

(22) Filed: Dec. 29, 2023

Related U.S. Application Data
(63) Continuation of application No. PCT/EP22/67696, filed on Jun. 28, 2022.

(30) Foreign Application Priority Data
Jun. 30, 2021 (EP) 21182992.4

(51) Int. Cl. H04W 64/00; H04L 5/00

(52) U.S. Cl. CPC H04W 64/00; H04L 5/0048

(57) ABSTRACT

A user equipment for transmitting and receiving data in a wireless communication system according to an embodiment is provided. At a point-in-time, the user equipment is in one of a plurality of radio resource control (RRC) states. For each radio resource control state of at least a first radio resource control state and a second radio resource control state of the plurality of radio resource control states, when the user equipment is in said radio resource control state, the user equipment is configured to transmit and/or to receive a reference signal for positioning depending on configuration information received from a network entity of the wireless communication system.

### CROSS-REFERENCE TO RELATED APPLICATIONS

This application is a continuation of International Application No. PCT/EP2022/067696, filed Jun. 29, 2022, which claims priority to European Application No. 21182992.4, filed Jun. 30, 2021, the contents of each of which are incorporated herein by reference in their entireties.

### TECHNICAL FIELD

The present invention relates to the field of wireless communication systems or networks, more specifically to user equipment positioning in RRC INACTIVE and RRC IDLE states.

### BACKGROUND OF THE INVENTION

FIG. 1 is a schematic representation of an example of a terrestrial wireless network 100 including, as is shown in FIG. 1(a), the core network and one or more radio access networks RAN1, RAN2, . . . RANN (RAN=Radio Access Network). FIG. 1(b) is a schematic representation of an example of a radio access network RANn that may include one or more base stations gNB1 to gNBS (gNB=next generation Node B), each serving a specific area surrounding the base station schematically represented by respective cells 1061 to 1065. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT (Internet of Things) devices which connect to a base station or to a user. The mobile devices or the IoT devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANn may include more or less such cells, and RANn may also include only one base station. FIG. 1(b) shows two users UE1 and UE2, (UE=User Equipment) also referred to as user equipment, UE, that are in cell 106₂ and that are served by base station gNB2. Another user UEs is shown in cell 106₄ which is served by base station gNB4. The arrows 108₁, 108₂ and 108₃ schematically represent uplink/downlink connections for transmitting data from a user UE1, UE2 and UEs to the base stations gNB2, gNB4 or for transmitting data from the base stations gNB2, gNB4 to the users UE1, UE2, UEs. This may be realized on licensed bands or on unlicensed bands. Further, FIG. 1(b) shows two IoT devices 110₁ and 110₂ in cell 106₄, which may be stationary or mobile devices. The IoT device 110₁ accesses the wireless communication system via the base station gNB4 to receive and transmit data as schematically represented by arrow 112₁. The IoT device 110₂ accesses the wireless communication system via the user UEs as is schematically represented by arrow 112₂. The respective base stations gNB₁ to gNB₅ may be connected to the core network 102, e.g. via the S1 interface, via respective backhaul links 114₁ to 114₅, which are schematically represented in FIG. 1(b) by the arrows pointing to “core”. The core network 102 may be connected to one or more external networks. The external network may be the Internet or a private network, such as an intranet or any other type of campus networks, e.g. a private WiFi or 4G or 5G mobile communication system. Further, some or all of the respective base stations gNB₁ to gNB₅ may be connected, e.g. via the S1 or X2 interface or the XN interface in NR (New Radio), with each other via respective backhaul links 116₁ to 116₅, which are schematically represented in FIG. 1(b) by the arrows pointing to “gNBs”. A sidelink channel allows direct communication between UEs, also referred to as device-to-device, D2D (Device to Device), communication. The sidelink interface in 3GPP (3G Partnership Project) is named PC5 (Proximity-based Communication 5).

For data transmission a physical resource grid may be used. The physical resource grid may comprise a set of resource elements to which various physical channels and physical signals are mapped. For example, the physical channels may include the physical downlink, uplink and sidelink shared channels, PDSCH (Physical Downlink Shared CHannel), PUSCH (Physical Uplink Shared Channel), PSSCH (Physical Sidelink Shared Channel), carrying user specific data, also referred to as downlink, uplink and sidelink payload data, the physical broadcast channel, PBCH (Physical Broadcast Channel), carrying for example a master information block, MIB, and one or more of a system information block, SIB, one or more sidelink information blocks, SLIBs, if supported, the physical downlink, uplink and sidelink control channels, PDCCH (Physical Downlink Control Channel), PUCCH (Physical Uplink Control CHannel), PSCCH (Physical Sidelink Control Channel), the downlink control information, DCI, the uplink control information, UCI, and the sidelink control information, SCI, and physical sidelink feedback channels, PSFCH (Physical sidelink feedback channel), carrying PC5 feedback responses. Note, the sidelink interface may support a 2-stage SCI (Speech Call Items). This refers to a first control region comprising some parts of the SCI, and, optionally, a second control region, which comprises a second part of control information.

For the uplink, the physical channels may further include the physical random-access channel, PRACH (Packet Random Access Channel) or RACH (Random Access Channel), used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols (OFDM=Orthogonal Frequency-Division Multiplexing) depending on the cyclic prefix, CP, length. A frame may also include of a smaller number of OFDM symbols, e.g. when utilizing a shortened transmission time interval, sTTI (slot or subslot transmission time interval), or a mini-slot/non-slot-based frame structure comprising just a few OFDM symbols.

The wireless communication system may be any single-tone or multicarrier system using frequency-division multiplexing, like orthogonal frequency-division multiplexing, OFDM, or orthogonal frequency-division multiple access, OFDMA (Orthogonal frequency-division multiple access), or any other IFFT-based signal (IFFT=Inverse Fast Fourier Transformation) with or without CP, e.g. DFT-s-OFDM (DFT=discrete Fourier transform). Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1 may be a heterogeneous network having distinct overlaid networks, e.g., a network of macro cells with each macro cell including a macro base station, like base stations gNB₁ to gNB₅, and a network of small cell base stations, not shown in FIG. 1, like femto or pico base stations. In addition to the above described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

In mobile communication networks, for example in a network like that described above with reference to FIG. 1, like an LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, or roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

In a wireless communication network, like the one depicted in FIG. 1, it may be desired to locate a UE with a certain accuracy, e.g., determine a position of the UE in a cell. Several positioning approaches are known, like satellite-based positioning approaches, e.g., autonomous and assisted global navigation satellite systems, A-GNSS, such as GPS, mobile radio cellular positioning approaches, e.g., observed time difference of arrival, OTDOA, and enhanced cell ID, E-CID, or combinations thereof.

It is noted that the information in the above section is only for enhancing the understanding of the background of the invention and, therefore, it may comprise information that does not form known technology that is already known to a person of ordinary skill in the art.

Starting from the above, there may be a need for improvements or enhancements for a wireless communication system or network and its components.

### SUMMARY

An embodiment may have a user equipment for transmitting and receiving data in a wireless communication system, wherein, at a point-in-time, the user equipment is in one of a plurality of radio resource control (RRC) states, wherein for each radio resource control state of at least a first radio resource control state and a second radio resource control state of the plurality of radio resource control states, when the user equipment is in said radio resource control state, the user equipment is configured to transmit and/or to receive a reference signal for positioning depending on configuration information received from a network entity of the wireless communication system.

Another embodiment may have a network entity of a wireless communication system, wherein the network entity is configured to transmit first configuration information to a user equipment of the wireless communication system, wherein the first configuration information is suitable for configuring the user equipment to transmit and/or to receive a reference signal for positioning during a first radio resource control state and during a second radio resource control state of the user equipment, or to transmit the first configuration information and second configuration information to the user equipment of the wireless communication system, wherein the first configuration information is suitable for configuring the user equipment to transmit and/or to receive the reference signal for positioning during the first radio resource control state of the user equipment, and wherein the second configuration information is suitable for configuring the user equipment to transmit and/or receive the reference signal for positioning during the second radio resource control state of the user equipment, and wherein the network entity is configured to transmit the reference signal for positioning to the user equipment, or the network entity is to receive the reference signal for positioning from the user equipment.

According to another embodiment, a system may have: a user equipment for transmitting and receiving data in a wireless communication system, wherein, at a point-in-time, the user equipment is in one of a plurality of radio resource control (RRC) states, wherein for each radio resource control state of at least a first radio resource control state and a second radio resource control state of the plurality of radio resource control states, when the user equipment is in said radio resource control state, the user equipment is configured to transmit and/or to receive a reference signal for positioning depending on configuration information received from a network entity of the wireless communication system, and an inventive network entity as mentioned above, wherein the network entity is configured to transmit configuration information to the user equipment, wherein the configuration information is suitable to configure the user equipment for transmitting and/or for receiving a reference signal for positioning during the second radio resource control state of the user equipment, and wherein the user equipment is configured to transmit and/or to receive the reference signal for positioning depending on the configuration information during the second radio resource control state of the user equipment.

Still another embodiment may have a method for transmitting and receiving data by a user equipment in a wireless communication system, wherein, at a point-in-time, the user equipment is in one of a plurality of radio resource control (RRC) states, wherein for each radio resource control state of at least a first radio resource control state and a second radio resource control state of the plurality of radio resource control states, when the user equipment is in said radio resource control state, the user equipment transmits and/or receives a reference signal for positioning depending on configuration information received from a network entity of the wireless communication system.

Another embodiment may have a method for a wireless communication system, wherein a network entity of the wireless communication system transmits first configuration information to a user equipment of the wireless communication system, wherein the first configuration information is suitable for configuring the user equipment to transmit and/or to receive a reference signal for positioning during a first radio resource control state and during a second radio resource control state of the user equipment, or transmits the first configuration information and second configuration information to the user equipment of the wireless communication system, wherein the first configuration information is suitable for configuring the user equipment to transmit and/or to receive the reference signal for positioning during the first radio resource control state of the user equipment, and wherein the second configuration information is suitable for configuring the user equipment to transmit and/or receive the reference signal for positioning during the second radio resource control state of the user equipment, and wherein the network entity transmits the reference signal for positioning to the user equipment, or the network entity receives the reference signal for positioning from the user equipment.

Another embodiment may have a non-transitory computer-readable medium having a computer program for implementing any of the above inventive methods, when the method is implemented by a computer or signal processor.

A user equipment for transmitting and receiving data in a wireless communication system according to an embodiment is provided. At a point-in-time, the user equipment is in one of a plurality of radio resource control (RRC) states. For each radio resource control state of at least a first radio resource control state and a second radio resource control state of the plurality of radio resource control states, when the user equipment is in said radio resource control state, the user equipment is configured to transmit and/or to receive a reference signal for positioning depending on configuration information received from a network entity of the wireless communication system.

Moreover, a network entity of a wireless communication system according to an embodiment is provided. The network entity is configured to transmit first configuration information to a user equipment of the wireless communication system, wherein the first configuration information is suitable for configuring the user equipment to transmit and/or to receive a reference signal for positioning during a first radio resource control state and during a second radio resource control state of the user equipment. Or, the network entity is configured to transmit the first configuration information and second configuration information to the user equipment of the wireless communication system, wherein the first configuration information is suitable for configuring the user equipment to transmit and/or to receive the reference signal for positioning during the first radio resource control state of the user equipment, and wherein the second configuration information is suitable for configuring the user equipment to transmit and/or receive the reference signal for positioning during the second radio resource control state of the user equipment. The network entity is configured to transmit the reference signal for positioning to the user equipment. Or, the network entity is to receive the reference signal for positioning from the user equipment.

Furthermore, a method for transmitting and receiving data by a user equipment in a wireless communication system, wherein, at a point-in-time, the user equipment is in one of a plurality of radio resource control (RRC) states. For each radio resource control state of at least a first radio resource control state and a second radio resource control state of the plurality of radio resource control states, when the user equipment is in said radio resource control state, the user equipment transmits and/or receives a reference signal for positioning depending on configuration information received from a network entity of the wireless communication system.

Moreover, a method for a wireless communication system according to an embodiment is provided. A network entity of the wireless communication system transmits first configuration information to a user equipment of the wireless communication system, wherein the first configuration information is suitable for configuring the user equipment to transmit and/or to receive a reference signal for positioning during a first radio resource control state and during a second radio resource control state of the user equipment. Or, the network entity transmits the first configuration information and second configuration information to the user equipment of the wireless communication system, wherein the first configuration information is suitable for configuring the user equipment to transmit and/or to receive the reference signal for positioning during the first radio resource control state of the user equipment, and wherein the second configuration information is suitable for configuring the user equipment to transmit and/or receive the reference signal for positioning during the second radio resource control state of the user equipment. The network entity transmits the reference signal for positioning to the user equipment. Or the network entity receives the reference signal for positioning from the user equipment.

Furthermore, a non-transitory computer program product comprising a computer readable medium storing instructions which, when executed on a computer, perform one of the above described methods is provided.

Further particular embodiments are provided in the dependent claims.

### BRIEF DESCRIPTION OF THE DRAWINGS

Embodiment of the present invention will be detailed subsequently referring to the appended drawings, in which:

FIG. 1 illustrates a schematic representation of an example of a terrestrial wireless network;

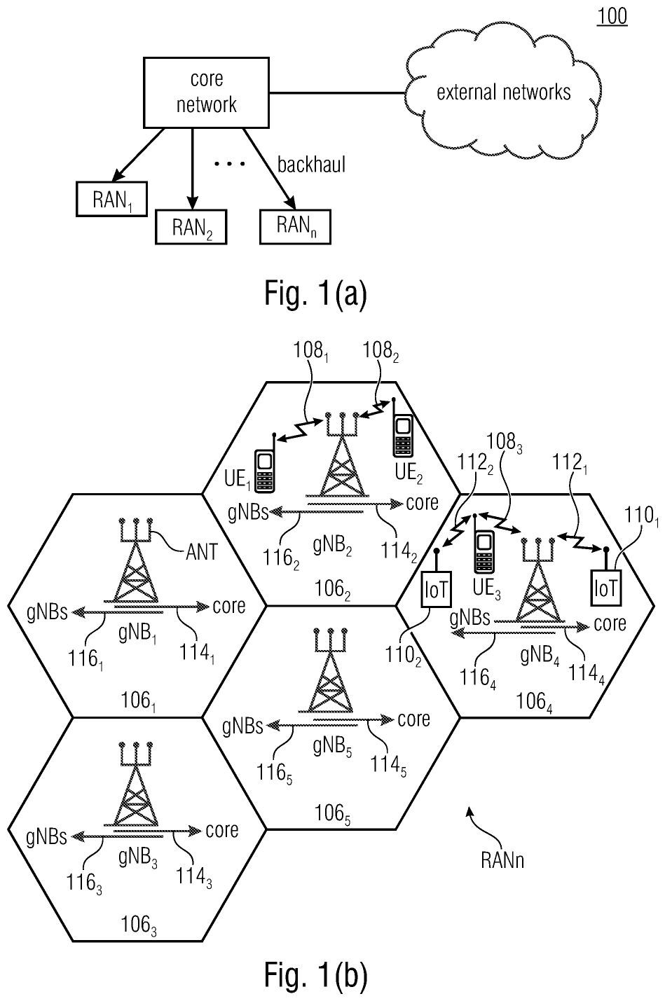

FIG. 2 illustrates a mobility of a UE and example RRC state transitions;

FIG. 3 illustrates a transition between different RRC states in NR;

FIG. 4 illustrates an example for a SRS-Position resource release 16 configuration;

FIG. 5 illustrates an example for positioning Resource Set RRC Messages; and

FIG. 6 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

A user equipment for transmitting and receiving data in a wireless communication system according to an embodiment is provided. At a point-in-time, the user equipment is in one of a plurality of radio resource control (RRC) states.

For each radio resource control state of at least a first radio resource control state and a second radio resource control state of the plurality of radio resource control states, when the user equipment is in said radio resource control state, the user equipment is configured to transmit and/or to receive a reference signal for positioning depending on configuration information received from a network entity of the wireless communication system.

According to an embodiment, when the user equipment is in the first radio resource control state, the user equipment may, e.g., be configured with network controlled mobility (e.g., handover is carried out with active control of the network). When the user equipment is in the second radio resource control state, the user equipment may, e.g., be configured with user equipment mobility which depends on a network configuration.

In an embodiment, when the user equipment is in the first radio resource control state, the user equipment may, e.g., be configured to monitor one or more control channels associated with one or more shared data channels, and/or may, e.g., be configured to monitor Short Messages transmitted with P-RNTI over DCI. When the user equipment is in the second radio resource control state, the user equipment may, e.g., be configured to monitor a paging channel for core network (CN) paging.

According to an embodiment, the first radio resource control state may, e.g., be a connected state (for example, an RRC_CONNECTED state) and the second radio resource control state may, e.g., be an inactive state (for example, an RRC_INACTIVE state) or may, e.g., be an idle state (for example, an RRC_IDLE state).

In an embodiment, the user equipment may, e.g., be configured to transmit information on a reception of the reference signal for positioning to a network entity of the wireless communication system.

In an embodiment, when the user equipment is in the first radio resource control state, the user equipment may, e.g., be configured to receive first configuration information for transmitting and/or for receiving the reference signal for positioning during the first radio resource control state of the user equipment, and the user equipment may, e.g., be configured to transmit and/or to receive the reference signal for positioning using the first configuration information. When the user equipment is in the second radio resource control state, the user equipment may, e.g., be configured to receive second configuration information for transmitting and/or for receiving reference signal for positioning during the second radio resource control state of the user equipment, and the user equipment may, e.g., be configured to transmit and/or to receive the reference signal for positioning using the second configuration information, wherein the second configuration information may, e.g., be different from the first configuration information.

According to an embodiment, when the user equipment is in the first radio resource control state, the user equipment may, e.g., be configured to receive first configuration information for transmitting and/or for receiving the reference signal for positioning during the first radio resource control state of the user equipment, and the user equipment may, e.g., be configured to transmit and/or to receive the reference signal for positioning using the first configuration information. When the user equipment is in the second radio resource control state, the user equipment may, e.g., be configured to transmit and/or to receive the reference signal for positioning using the first configuration information.

In an embodiment, the first configuration information comprises a first resource (ID) identifier identifying a reference signal (RS) resource or resource set (for example a first uplink positioning reference signal (SRS), or, for example a first downlink positioning reference signal (PRS)). And/or, the second configuration information comprises a second resource (ID) identifier identifying a second reference signal (RS) resource or resource set (for example a second uplink positioning reference signal (SRS), or, for example a second downlink positioning reference signal (PRS)).

In an embodiment, wherein the user equipment may, e.g., be configured to transmit capabilities information to the network entity, wherein the capabilities information comprises an indication that the user equipment supports a transmission and/or a reception of the reference signal during the second radio resource control state. After transmitting the capabilities information, the user equipment may, e.g., be configured to receive from the network entity the configuration information for transmitting and/or receiving the reference signal for positioning during the second radio resource control state.

In an embodiment, the configuration information (which, for example, comprises a definition of a sequence) comprises information on a validity information (e.g., a validity condition). The user equipment may, e.g., be configured to determine whether or not the configuration information is currently valid for the user equipment depending on the validity condition. The configuration information may, e.g., also comprise information for deriving an RE allocation. An example are the IEs in the SRS resource/in the SRS resource set.

In an embodiment, the configuration information (which, for example, comprising a definition of a sequence) comprises information on a validity information (e.g., a validity condition). The user equipment may, e.g., be configured to determine whether or not the configuration information is currently valid for the user equipment depending on the validity condition.

According to an embodiment, the validity information comprises information on a validity area. The user equipment may, e.g., be configured to determine or to receive information on whether or not the user equipment is located within the validity area. If the user equipment is located within the validity area, the user equipment may, e.g., be configured to transmit and/or to receive the reference signal for positioning depending on the configuration information during the second radio resource control state of the user equipment. If the user equipment is located outside of the validity area, the user equipment may, e.g., be configured to not transmit and/or to not receive the reference signal for positioning depending on the configuration information during second radio resource control state of the user equipment.

According to an embodiment, the validity area may, e.g., be determined by the signal strength of a downlink reference signal selected by the network as signal for identifying the area.

In an embodiment, the validity condition comprises an information which can be derived from a non-user-equipment-specific signaling channel, e.g., a broadcast channel or a channel addressing a group of user equipments.

In an embodiment, the validity information comprises information on a validity timer. The user equipment may, e.g., be configured to determine whether or not the validity timer has expired. If the validity timer has not expired, the user equipment may, e.g., be configured to transmit and/or to receive the reference signal for positioning depending on the configuration information during the second radio resource control state of the user equipment. If the validity timer has expired, the user equipment may, e.g., be configured to not transmit and/or to not receive the reference signal for positioning depending on the configuration information during second radio resource control state of the user equipment.

According to an embodiment, the validity information comprises information on a validity timer. If the user equipment transits from the first radio resource control state to the second radio resource control state, the user equipment may, e.g., be configured to continue transmitting and/or receiving the reference signal for positioning depending on the configuration information as long as the validity timer has not expired.

In an embodiment, the user equipment may, e.g., be configured to receive the validity timer by receiving a suspendConfig or a RRCSuspend message which comprises the validity timer.

According to an embodiment, the user equipment may, e.g., be configured to start the validity timer when the user equipment receives the suspendConfig or the RRC suspend message.

According to an embodiment, if the user equipment is located outside the validity area or if the validity timer has expired, the user equipment may, e.g., be configured to stop transmitting the reference signal for positioning.

In an embodiment, the configuration information may, e.g., comprise configuration information for transmitting and/or for receiving the reference signal for positioning during the connected state of the user equipment comprises a first transmission characteristics. The configuration information for transmitting the reference signal for positioning during the second radio resource control state of the user equipment may, e.g., comprise a second transmission characteristics, being different from the first transmission characteristics. When the user equipment is in the first radio resource control state, the user equipment may, e.g., be configured to transmit the reference signal for positioning in accordance with the first transmission characteristics. When the user equipment is in the second radio resource control state, the user equipment may, e.g., be configured to transmit the reference signal for positioning in accordance with the second transmission characteristics.

According to an embodiment, the configuration information comprises information on a validity timer. The user equipment may, e.g., be configured to determine whether or not the validity timer has expired. If the validity timer has not expired, the user equipment may, e.g., be configured to transmit the reference signal for positioning depending on the configuration information during the inactive state and/or during the idle state of the user equipment. If the validity timer has expired, the user equipment may, e.g., be configured to not transmit the reference signal for positioning depending on the configuration information during the inactive state and/or during the idle state of the user equipment.

In an embodiment, the configuration information for transmitting the reference signal for positioning during the first radio resource control state of the user equipment comprises a first transmission characteristics. The configuration information for transmitting the reference signal for positioning during the second radio resource control state of the user equipment comprises a second transmission characteristics, being different from the first transmission characteristics. When the user equipment is in the first radio resource control state the user equipment may, e.g., be configured to transmit the reference signal for positioning in accordance with the first transmission characteristics. When the user equipment is in the second radio resource control state, the user equipment may, e.g., be configured to transmit the reference signal for positioning in accordance with the second transmission characteristics.

According to an embodiment, the user equipment may, e.g., be configured to receive an indication on a state validity for one or more uplink positioning reference signal resources or one or more uplink positioning reference signal resource sets. The user equipment may, e.g., be configured to select at least one of the one or more uplink positioning reference signal resources or one or more uplink positioning reference signal resource sets for transmitting the reference signal for positioning depending on the indication on the state validity.

In an embodiment, when the user equipment is in the first radio resource connected state, the user equipment may, e.g., be configured to receive the configuration information for transmitting the reference signal for positioning during the first radio resource connected state of the user equipment from the network entity over a first interface. When the user equipment is in the second radio resource connected state, the user equipment may, e.g., be configured to receive the configuration information for transmitting the reference signal for positioning during an inactive state and/or during an idle state of the user equipment as updated configuration information over a second interface from the network entity, wherein the updated configuration information updates at least one parameter and/or at least one transmission setting of the configuration information, while a least one other parameter and/or at least one other transmission setting of the configuration information may, e.g., be left unchanged, wherein for example, the second interface may, e.g., be a posSIB, or a SI or a SDT/R interface.

According to an embodiment, when the user equipment is in the second radio resource control state, the user equipment may, e.g., be configured to receive the configuration information over an interface as a complete configuration information so that the user equipment does not continue to any use parameter value of any parameter and any transmission setting of the configuration information received when the user equipment has been in the first radio resource control state.

In an embodiment, when the user equipment may, e.g., be in the second radio resource control state, the user equipment may, e.g., be configured to receive an indication indicating that the configuration information may, e.g., be no longer valid. The user equipment may, e.g., be to switch from the second radio resource control state to the first radio resource control state in response to receiving said indication.

According to an embodiment, after receiving the configuration information during the second radio resource control state of the user equipment, the user equipment may, e.g., be configured to receive updated configuration information that updates the configuration information while the user equipment may, e.g., be still in the second radio resource control state.

In an embodiment, the user equipment may, e.g., be configured to receive further parameters for transmitting and/or for receiving the reference signal for positioning, which have not been specified in the configuration information, via unicast signaling; or the user equipment may, e.g., be configured to derive said further parameters using a user equipment identity, for example, 5G-S-TMSI, or I-RNTI, SUPI (subscription permanent identifier), SUCI (subscription concealed identifier), IMEI, of the user equipment.

According to an embodiment, the UE may send a request to the NG-RAN node (e.g. using the SDT mechanism) for requesting the values of certain parameters that are not specified in the provided partial configuration for transmitting the SRS during first or second state. The NG-RAN node may acknowledge the request and/or provide a configuration to supplement the provided partial configuration.

According to an embodiment, a sequence of the reference signal for positioning depends on the I-RNTI or the 5G-S-TMSI; and/or a cyclic shift and/or a comb offset of the reference signal for positioning depends on a last known physical cell identifier or global cell identifier or the NR-cell (NR-CGI), where the user equipment was detached.

In an embodiment, for transmitting the reference signal for positioning, when the user equipment is in the second radio resource control state, the user equipment may, e.g., be configured to determine a comb offset, and/or a slot, and/or a cyclic shift, and/or a sequence identifier depending on an user equipment identifier of the user equipment and/or depending on an identifier of the network entity the user equipment has been connected to, wherein, for example, the user equipment identifier may, e.g., be a C-RNTI or a 5G-TMSI, SUPI (subscription permanent identifier), SUCI (subscription concealed identifier), IMEI, etc, or even one of the parameters assigned to the UE for one of the SRS resources (e.g. the SRS ID) used during the first radio resource control state.

According to an embodiment, the configuration information comprises two or more configurations for user equipment in the inactive and/or in the idle state. The user equipment may, e.g., be configured to receive a selection configuration from the network entity. Moreover, the user equipment may, e.g., be configured to use one of the two or more configurations depending on the selection configuration for transmitting and/or for receiving the reference signal for positioning during the second radio resource control state.

In an embodiment, an area identifier and a configuration version may, e.g., be stored in the user equipment. The user equipment may, e.g., be configured to receive a received area identifier and a valid configuration version. When the user equipment is in the second radio resource control state, if the received area identifier is equal to the area identifier being stored and if the valid configuration version is equal to the configuration version being stored, the user equipment may, e.g., be configured to transmit and/or to receive the reference signal for positioning in the second radio resource control state. When the user equipment is in the second radio resource control state, if the received area identifier is different from the area identifier being stored and/or the valid configuration version is different from the configuration version being stored, the user equipment may, e.g., be configured to switch to the first radio resource control state.

According to an embodiment, the user equipment may, e.g., be configured to receive a message from the network entity that transmitting the reference signal for positioning may, e.g., be not allowed in a particular cell when the user equipment is in the second radio resource control state. The user equipment may, e.g., be configured to not transmit the reference signal for positioning when the user equipment is in the second radio resource control state, while the user equipment is located in said cell.

In an embodiment, if transmitting the reference signal for positioning is not allowed in the particular cell where the user equipment is currently located and if the user equipment is in the second radio resource control state, the user equipment and a LMF (location management function or location management server) may, e.g., be configured to switch to a different positioning method, e.g., to DL-TDOA or DL-ECID or GNSS or OTDOA for a given UE. For example, if an LMF is involved UE switches to “network based OTDOA.

According to an embodiment, the user equipment may, e.g., comprise an LCS client is in the UE. The user equipment may, e.g., be configured to receive information from a LMF that the integrity indicators (e.g., a protection level, and/or an alert limit and/or a time to alert and/or target integrity risk) and/or reliability and/or QoS parameters associated with the positioning could have changed.

According to an embodiment, the LMF may, e.g., be to inform an LCS client that the integrity indicators (e.g., a protection level, alert limit, time to alert, target integrity risk) and/or reliability and/or QoS parameters associated with the positioning could have changed.

The integrity parameters may, for example, be one or more or all of the following:

Protection Level: The PL is a statistical upper-bound of the Positioning Error (PE) that ensures that, the probability per unit of time of the true error being greater than the AL and the PL being less than or equal to the AL, for longer than the TTA, is less than the required TIR, i.e., the PL satisfies the following inequality:

Prob per unit of time [((PE>AL) & (PL<=AL)) for longer than TTA]<required

Target Integrity Risk (TIR): The probability that the positioning error exceeds the Alert Limit (AL) without warning the user within the required Time-to-Alert (TTA).

NOTE: The TIR is usually defined as a probability rate per some time unit (e.g., per hour, per second or per independent sample).

Alert Limit (AL): The maximum allowable positioning error such that the positioning system is available for the intended application. If the positioning error is beyond the AL, the positioning system should be declared unavailable for the intended application to prevent loss of positioning integrity.

It should be noted that when the AL bounds the positioning error in the horizontal plane or on the vertical axis then it is called Horizontal Alert Limit (HAL) or Vertical Alert Limit (VAL), respectively.

Time-to-Alert (TTA): The maximum allowable elapsed time from when the positioning error exceeds the Alert Limit (AL) until the function providing positioning integrity annunciates a corresponding alert.

Integrity Availability: The integrity availability is the percentage of time that the PL is below the required AL.

The relationship between the KPIs and the Protection Level (PL), and their impacts on the positioning solution are further examined below.

According to an embodiment, the NG-RAN node may inform the LMF using NRPPa signaling and/or a UE may inform the LMF using LPP signaling, the RRC state of the UE.

In an embodiment, if the user equipment is not allowed to transmit the reference signal for positioning during the second radio resource control state, the user equipment is configured to receive the configuration information from a LMF (location management function or a location management server), which configures the user equipment with another positioning method, after the NG-RAN has informed a LMF that the user equipment may, e.g., be not allowed to transmit the reference signal for positioning during the second radio resource control state.

According to an embodiment, the user equipment may, e.g., be configured to select a configuration out of two or more configurations for transmitting the reference signal for positioning in a cell in which the user equipment is located, such that the configuration being selected is allowed in an area (e.g. a cell or a positioning system information area or a system information area, RNA, or a tracking area) in which the user is located.

In an embodiment, the user equipment may, e.g., be configured to receive a signaling that indicates that the information for configuration for transmitting the reference signal for positioning, when the user equipment in the first radio resource control state, may, e.g., be also valid when the user equipment is in the second radio resource control state. The user equipment may, e.g., be configured to transmit the reference signal for positioning depending on the configuration information for the first radio resource control state, if the user equipment receives said signaling.

According to an embodiment, when the user equipment may, e.g., be no longer located in a validity area or when a validity of a configuration for transmitting the reference signal for positioning expires, the user equipment no longer uses a current configuration for transmitting the reference signal for positioning.

In an embodiment, the user equipment may, e.g., be configured to receive updates on a configuration for transmitting the reference signal for positioning may, e.g., be updated during periodic RAN updates.

According to an embodiment, the user equipment may, e.g., be configured to receive a notification which one or more parameters of the configuration information must be updated if the user equipment should move from its current cell to another cell. If the user equipment moves to said other cell and if the user equipment receives an update for said one or more parameters, the user equipment may, e.g., be configured to continue transmitting the reference signal for positioning during the second radio resource control state depending on the update. If the user equipment moves to said other cell and if the user equipment does not receive any update for said one or more parameters, the user equipment may, e.g., be configured to stop transmitting the reference signal for positioning during the second radio resource control state.

In an embodiment, the user equipment may, e.g., be configured to receive a group of parameters necessary for transmitting the reference signal for positioning. One or more further parameters necessary for transmitting the reference signal for positioning are not provided within the group of parameters. When the user equipment is in the second radio resource control state and receives said one or more further parameters or information for deriving said one or more further parameters in a first cell, the user equipment may, e.g., be configured to start transmitting the reference signal for positioning. When the user equipment is in the second radio resource control state, and when the user equipment moves to another cell and again receives said one or more further parameters or information for deriving said one or more further parameters, the user equipment may, e.g., be configured to continue transmitting the reference signal for positioning. When the user equipment is in the second radio resource control state, and when the user equipment moves to another cell and does not receive said one or more further parameters and does not receive information for deriving said one or more further parameters, the user equipment may, e.g., be configured to stop transmitting the reference signal for positioning.

According to an embodiment, when the user equipment moves outside an RNA or outside a TAC area where the user equipment has received the configuration information for transmitting the reference signal for positioning during the second radio resource control state of the user equipment, the user equipment may, e.g., be configured to stop transmitting the reference signal for positioning and to request updated configuration information, wherein, for example, the user equipment may, e.g., be to request the updated configuration information during a RAN update or during a TAC update.

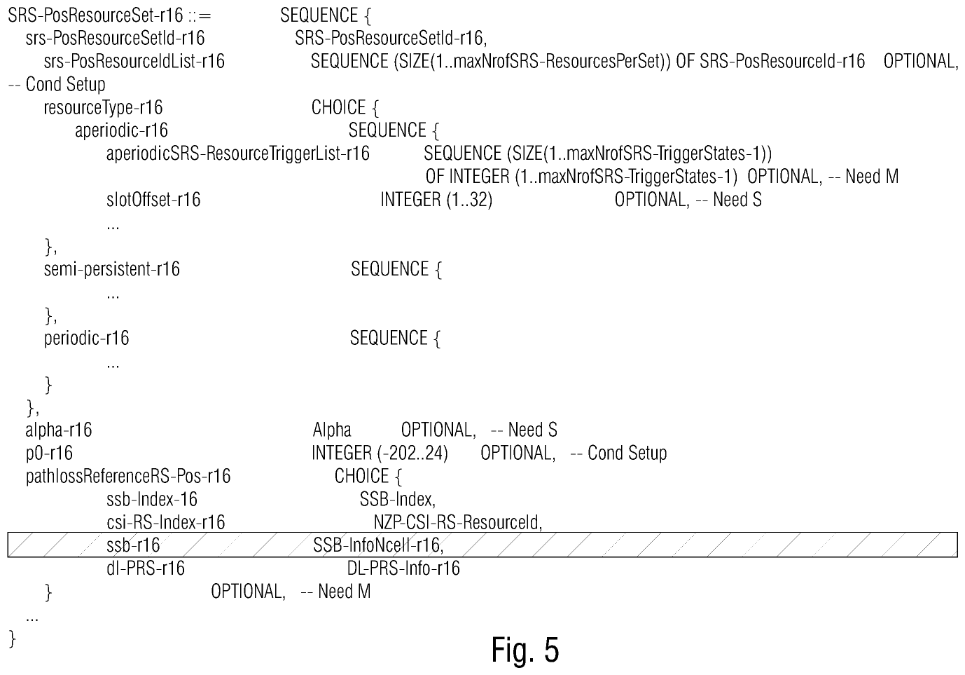

Regarding the transmit power, three alternatives are possible: Alternative 1: A fixed UE power (where the downlink reference signal is only an indicator of location of UE in an RNA); Alternative 2: Maintaining the the power control procedure and/or parameters of first state during the second state, or, scenario 3: To use different PC (power control) parameters during the second radio resource control state. All of the above three scenarios can be realized by simply setting the configuration accordingly. For example: the first scenario is achieved by setting the value of the parameters so as not to compensate the pathloss and use triggering mechanism based on which PL is detected (i.e. transmit if received RSRP>x and stop transmitting if RSRP<y) (RSRP=Reference Signal Received Power). By setting the value of alpha (e.g. alpha_r16) defined in SRS-PosResourceSet-r16 (for example) to 0, the PL compensation can be disabled. pathlossReferenceRS (e.g. pathlossReferenceRS-Pos-r16) in FIG. 5 can be set to a certain SSB. Then the triggering mechanism could be defined. Regarding Alternative 2 the parameters (FIG. 5) are provided similar to the parameters in RRC_CONNECTED and same power control procedure is applied. Regarding the third alternative, different values of target power at TRP assuming 0 dB pathloss between UE and TRP, p0 (e.g. p0-16) and fractional pathloss compensation, alpha (e.g. alpha-r16) for RRC_INACTIVE from RRC_CONNECTED are provided and the same power control procedure is used in the first state as in the second state.

According to an embodiment, the user equipment may, e.g., be configured to transmit the reference signal for positioning in a first uplink when the user equipment is in the first radio resource control state. The user equipment may, e.g., be configured to transmit the reference signal for positioning in a supplementary uplink when the user equipment is in the second radio resource control state.

In an embodiment, the user equipment may, e.g., be configured to receive and use a supplementary uplink configuration for transmitting the reference signal for positioning in the supplementary uplink when the user equipment is in the second radio resource control state.

According to an embodiment, the user equipment may, e.g., be configured to receive and use a spatial filter and/or a beam direction for transmitting the reference signal for positioning in one or more uplink reference signal resources or resource sets. This may, e.g., be done based on measurement, and events may, e.g., be used to select the spatial filter from the configured table, similar to TA. Or this may be done by using the same spatial filter used to receive the SSB in the camped cell, as a fallback.

The transmit beam may, e.g., also be derived based on measurements. The outcome of measurement map to a spatial filter preconfigured or as a fallback use the same spatial filter as the one used to receive SSB on the camped cell.

In an embodiment, the user equipment may, e.g., be configured to receive an indication to employ beam sweeping, and wherein the user equipment may, e.g., be to employ beam sweeping for transmitting the reference signal for positioning when receiving the indication.

According to an embodiment, the user equipment may, e.g., be configured to receive from the network entity assistance data (for example, a time-frequency location) for measuring a downlink reference signal. The user equipment may, e.g., be configured to measure the downlink reference signal during the second radio resource control state of the user equipment depending on the assistance data.

In an embodiment, the user equipment may, e.g., be configured to receive an update or correction of the assistance data from the network entity using paging or on a resource for short data which the user equipment is configured to monitor in the second radio resource control state.

According to an embodiment, the user equipment may, e.g., be configured to select a configuration as a selected configuration from a set of configurations available to a group of user equipments, and may, e.g., be configured to inform, for example, by using a small data transmission, the network entity on the selected configuration, for example, by signaling a configuration index indicating the selected configuration. The user equipment may, e.g., be configured to transmit SRS using user specific parameters, for example, a SRS sequence and/or a cyclic shift, to the network entity. Moreover, the user equipment may, e.g., be configured to receive a user-specific configuration before an RRC_Suspend is provided and or as a part of suspendConfig in the RRC_Suspend message. Furthermore, the user equipment may, e.g., be configured to use the user-specific configuration until a cell-reselection. Moreover, the user equipment may, e.g., be configured to receiving information when the user-specific configuration changes.

In an embodiment, when the user equipment is in the second radio resource control state, the user equipment may, e.g., be configured to receive, as system information or via an SDT mechanism, an uplink reference signal resource or resource set configuration comprising an inactive and/or idle indication. When the user equipment is in the second radio resource control state, the user equipment may, e.g., be configured to begin transmitting, depending on the uplink reference signal resource or resource set configuration, a periodic transmission of the reference signal for positioning on receiving an activation indication.

According to an embodiment, when the user equipment may, e.g., be in the first radio resource control state, the user equipment may, e.g., be configured to receive an uplink reference signal resource or resource set configuration. When the user equipment switches into the second radio resource control state, the user equipment may, e.g., be configured to begin transmitting a periodic transmission of the reference signal for positioning depending on the uplink reference signal resource or resource set configuration.

In an embodiment, the user equipment may, e.g., be configured to deactivate the transmission of the reference signal for positioning when a handover from the first network entity being a first base station to a second base station occurs.

According to an embodiment, the user equipment may, e.g., be configured to deactivate or to keep the transmission of the reference signal for positioning activated depending on whether or not one or more validity conditions are met, wherein the validity conditions, for example, depend on an area identifier, for example, a positioning area identifier or a tracking area identifier or a radio area identifier, and/or depend on an activity timer.

In an embodiment, the user equipment may, e.g., be configured to receive and use an uplink reference signal resource configuration (for example, in the first radio resource control state and in the second radio resource control state) for transmitting the reference signal for positioning. When the user equipment is in the second radio resource control state, the user equipment may, e.g., be configured to measure one or more downlink positioning reference signal resources from a base station. The uplink reference signal resource configuration may, e.g., be associated with the one or more downlink positioning reference signal resources.

For example, the UE may, e.g., stop transmitting SRS, if the associated DL-RS cannot accurately be determined.

According to an embodiment, the uplink reference signal resource configuration comprises an indication on one or more downlink positioning reference signal resources.

In an embodiment the user equipment may, e.g., be configured to select associated downlink positioning reference signal resources for spatial relation and/or for pathloss determination depending on a measurement of the downlink positioning reference signal resources.

According to an embodiment, the indication on the one or more downlink positioning reference signal resources comprises a resource set identifier and/or a TRP identifier. The user equipment may, e.g., be configured to select associated downlink positioning reference signal resources within an indicated resource set or TRP being indicated by the resource set identifier and/or a TRP identifier depending on a measurement of the downlink positioning reference signal resources.

In an embodiment, the user equipment refrains from transmitting an uplink reference signal in the second radio resource control state if the associated DL-PRS is not detected or detected with poor quality by the user equipment.

According to an embodiment, the user equipment may, e.g., be configured to transmit an uplink reference signal in the second radio resource control state with a predetermined default configuration, if an associated downlink positioning reference signal (DL-PRS) is not detected or detected with poor quality by the user equipment.

For example, if the UE is configured for transmission of SRS-PosResource in RRC_INACTIVE mode, a configured spatialRelationInfoPos may, e.g., also be applicable.

E.g., if the UE in RRC_INACTIVE mode determines that the UE is not able to accurately measure the configured DL RS in SRS-SpatialRelationInfoPos for a SRS resource for positioning where the DL RS is semi-persistent or periodic, the UE may, e.g., stop transmission of the SRS resource for positioning.

In an embodiment, when the user equipment may, e.g., be in the inactive state and/or the idle state, the user equipment may, e.g., be configured to measure one or more downlink positioning reference signal resources from the network entity being a base station. The user equipment may, e.g., be configured to receive and use an uplink reference signal resource configuration for transmitting the reference signal for positioning, wherein the uplink reference signal resource configuration depends on the one or more downlink positioning reference signal resources.

According to an embodiment, the user equipment may, e.g., be configured to receive information on a polarity of the one or more downlink positioning reference signal resources.

In an embodiment, the user equipment may, e.g., be configured to transmit to the network entity an indication on a capability of the user equipment to receive the configuration information for the reference signal for positioning during an inactive state and/or during an idle state of the user equipment. And/or the user equipment may, e.g., be configured to transmit to the network entity an indication on a capability of the user equipment to receive an update of the configuration information for the reference signal for positioning during an inactive state and/or during an idle state of the user equipment.

According to an embodiment, the user equipment may, e.g., be configured to transmit, for example, via SDT, a request for transmitting the configuration information for transmitting the reference signal for positioning. The user equipment may, e.g., be configured to receive the configuration information for transmitting the reference signal for positioning in response to transmitting the request.

In an embodiment, the user equipment may, e.g., be configured to transmit the request for transmitting the configuration information by specifying at least one parameter of:
a selection of a bandwidth part from a list of bandwidth parts configured for the user equipment,
a parameter for characterizing a reference signal for positioning, for example, a transmission comb number or a comb offset,
a request requesting transmitting the reference signal for positioning on a normal carrier or on a supplemental carrier.

According to an embodiment, the user equipment may, e.g., be configured to begin to transmit or to stop to transmit the reference signal for positioning depending on whether or not an event is triggered.

In an embodiment, the user equipment may, e.g., be configured to stop to transmit the reference signal for positioning if it is triggered as the event that a timing advance cannot be validated. For example, in an embodiment, the user equipment may, e.g., stop transmitting reference signals (e.g., sounding reference signals) if a timing advance (TA) cannot be validated.

According to an embodiment, the user equipment may, e.g., be the user equipment is configured to stop to transmit the reference signal for positioning depending a Reference Signal Received Power for a downlink reference signal. Whether or not a TA cannot be validated may, e.g., be determined by a user equipment depending on a Reference Signal Received Power (RSRP) determined on a downlink reference signal (DL RS). For example, a measObject may, e.g., represent a configuration for a downlink reference signal. Measurements on synchronisation sequences (part of SSB) may, e.g., usually be conducted. A RSRP may, e.g., impact a TA which in-turn impacts whether the signal is transmitted or not.

In an embodiment, the user equipment may, e.g., be configured to measure a downlink reference signal. The user equipment may, e.g., be configured to transmit the reference signal for positioning depending on the measuring of the downlink reference signal.

According to an embodiment, the user equipment may, e.g., be configured to apply one or more of the following rules:
avoid transmitting (e.g., the reference signal for positioning) using a configuration associated with the said downlink reference signal, if the measured value is below a certain threshold value configured by the network;
avoid transmitting using the configuration associated with the said downlink reference signal, if the measured value is above a certain threshold value configured by the network;
transmit using the configuration associated with the said downlink reference signal, if the measured value is above a certain threshold value configured by the network;
transmit using the configuration associated with the said downlink reference signal, if the measured value is below a certain threshold value configured by the network;
transmit using the configuration associated with the said downlink reference signal, if the measured value is below a first threshold value configured by the network and above a second threshold value configured by the network.

For example, in an embodiment, a periodic and/or semi-persistent Positioning SRS may, e.g., be configured for Positioning SRS transmission in RRC_INACTIVE. If the TA of the configured Positioning SRS is valid, the MAC entity may, e.g., transmit Positioning Periodic SRS or Semi-Persistent SRS. For validation for SRS transmission in RRC_INACTIVE, the RRC may, e.g., configure an inactivePosSRS-RSRP-ChangeThreshold and/or an RSRP threshold for the increase/decrease of RSRP for time alignment validation. If the UE is configured with measObject for the Serving Cell, where the UE receives configuration for SRS transmission in RRC_INACTIVE, the MAC entity may, e.g., store the RSRP of the downlink pathloss reference derived based on the measObject configured for the Serving Cell. Else, if Timing Advance Command MAC CE is received for inactivePosSRS-TimeAlignmentTimer, the MAC entity may, e.g., update the stored downlink pathloss reference with the current RSRP value of the downlink pathloss reference. The MAC entity may, e.g., consider the TA to be valid, if, compared to the stored downlink pathloss reference RSRP value, the current RSRP value of the downlink pathloss reference has not increased/decreased by more than the inactivePosSRS-RSRP-ChangeThreshold, if configured.

In an embodiment, the user equipment may, e.g., be configured to measure a downlink reference signal. The user equipment may, e.g., be configured to transmit an uplink reference signal depending on the measuring of the downlink reference signal.

For example, In an embodiment, the UE may, e.g., stop transmitting reference signals, if the associated DL-RS cannot be accurately determined.

E.g., according to an embodiment, the UE may, e.g., transmit or may, e.g., stop transmitting a small data transmission (e.g., including an uplink reference signal—but, e.g., not a positioning reference signal) based on the changes in RSRP measured on synchronisation sequences (e.g., a downlink signal, but, e.g., not a downlink reference signal).

According to an embodiment, the user equipment may, e.g., be configured to apply one or more of the following rules:
avoid transmitting (e.g., the uplink reference signal) using a configuration associated with the said downlink reference signal, if the measured value is below a certain threshold value configured by the network;
avoid transmitting using the configuration associated with the said downlink reference signal, if the measured value is above a certain threshold value configured by the network;
transmit using the configuration associated with the said downlink reference signal, if the measured value is above a certain threshold value configured by the network;
transmit using the configuration associated with the said downlink reference signal, if the measured value is below a certain threshold value configured by the network;
transmit using the configuration associated with the said downlink reference signal, if the measured value is below a first threshold value configured by the network and above a second threshold value configured by the network.

For example, regarding Small Data Transmission (SDT), a MAC entity may, e.g., be configured by RRC with SDT, and the SDT procedure may, e.g., be initiated by an RRC layer. For SDT procedure, the RRC may, e.g., configure a sdt-DataVolumeThreshold being a data volume threshold for the UE to determine whether to perform SDT procedure, a sdt-RSRP-Threshold being RSRP threshold for UE to determine whether to perform SDT procedure, and a cg-SDT-RSRP-ThresholdSSB being an RSRP threshold configured for SSB selection for CG-SDT (CG-SDT=Configured Grant-based SDT).

Regarding TA Validation for CG-SDT, RRC may, e.g., configure cg-SDT-RSRP-ChangeThreshold for validation for CG-SDT, wherein the cg-SDT-RSRP-ChangeThreshold may, e.g., be a RSRP threshold for the increase/decrease of RSRP for time alignment validation. If the UE is configured with measObject for the Serving Cell where the UE receives configuration for CG-SDT, the MAC entity may, e.g., store the RSRP of the downlink pathloss reference derived based on the measObject configured for the Serving Cell. The MAC entity may, e.g., consider the TA of the initial CG-SDT transmission with CCCH message to be valid, when compared to the stored downlink pathloss reference RSRP value, the current RSRP value of the downlink pathloss reference calculated has not increased/decreased by more than cg-SDTRSRP-ChangeThreshold, if configured; with the cg-SDT-TimeAlignmentTimer running.

For example, if the RSRP of the downlink pathloss reference is higher than sdt-RSRP-Threshold, then if the Serving Cell for SDT is configured with supplementary uplink and if the RSRP of the downlink pathloss reference is less than rsrp-ThresholdSSB-SUL, the MAC entity may, e.g., select the SUL carrier, and else may, e.g., select the NUL carrier.

If CG-SDT is configured on the selected UL carrier, and TA of the configured grant Type 1 resource is valid, and if at least one SSB configured for CG-SDT with SS-RSRP above cg-SDT-RSRP-ThresholdSSB is available, then the MAC entity may, e.g., indicate to the upper layers that the conditions for initiating SDT procedure are fulfilled, and may, e.g., perform the CG-SDT procedure on the selected UL carrier. Otherwise, if a set of Random Access resources to indicate RA-SDT are on the selected UL carrier, the MAC entity may, e.g., consider cg-SDT-TimeAlignmentTimer as expired.

In an embodiment, the user equipment may, e.g., be configured to conduct the measurement of the downlink reference signal by conducting a timing measurement, for example, a ToA, or a RSTD, or a ToF, or by conducting a power measurement, for example, a RSRP, or a RSSI.

Moreover, a network entity of a wireless communication system according to an embodiment is provided.

The network entity is configured to transmit first configuration information to a user equipment of the wireless communication system, wherein the first configuration information is suitable for configuring the user equipment to transmit and/or to receive a reference signal for positioning during a first radio resource control state and during a second radio resource control state of the user equipment. Or, the network entity is configured to transmit the first configuration information and second configuration information to the user equipment of the wireless communication system, wherein the first configuration information is suitable for configuring the user equipment to transmit and/or to receive the reference signal for positioning during the first radio resource control state of the user equipment, and wherein the second configuration information is suitable for configuring the user equipment to transmit and/or receive the reference signal for positioning during the second radio resource control state of the user equipment.

The network entity is configured to transmit the reference signal for positioning to the user equipment. Or, the network entity is to receive the reference signal for positioning from the user equipment.

According to an embodiment, when the user equipment is in the first radio resource control state, the user equipment may, e.g., exhibit network controlled mobility. When the user equipment is in the second radio resource control state, the user equipment may, e.g., exhibit user equipment mobility which depends on a network configuration.

In an embodiment, when the user equipment is in the first radio resource control state, the user equipment may, e.g., be monitoring one or more control channels associated with one or more shared data channels, and/or is configured to monitor Short Messages transmitted with P-RNTI over DCI. When the user equipment is in the second radio resource control state, the user equipment may, e.g., be monitoring a paging channel for core network (CN) paging.

According to an embodiment, the first radio resource control state of the user equipment may, e.g., be a connected state (for example, an RRC_CONNECTED state) and the second radio resource control state of the user equipment may, e.g., be an inactive state (for example, an RRC_INACTIVE state) or is an idle state (for example, an RRC_IDLE state).

In an embodiment, the network entity may, e.g., be configured to transmit the first configuration information and the second configuration information to the user equipment, wherein the second configuration information may, e.g., be different from the first configuration information.

According to an embodiment, the network entity may, e.g., be configured to receive capabilities information from the user equipment, wherein the capabilities information comprises an indication that the user equipment supports a transmission and/or a reception of the reference signal during the second radio resource control state of the user equipment. After receiving the capabilities information, the network entity may, e.g., be configured to transmit to the user equipment the second configuration information for transmitting and/or for receiving the reference signal for positioning during the second radio resource control state of the user equipment.

According to an embodiment, the reference signal for positioning may, e.g., be an uplink positioning reference signal (UL-SRS) or may, e.g., be a downlink positioning reference signal (DL-PRS).

In an embodiment, the network entity may, e.g., be a base station.

According to an embodiment, the network entity may, e.g., be a location management function or may, e.g., be a location management server.

In an embodiment, the configuration information may, e.g., comprise information on a validity area, and/or the configuration information may, e.g., comprise information on a validity timer.

According to an embodiment, the validity area may, e.g., be determined by a signal strength of a downlink reference signal selected by network as a signal for identifying the validity area.

According to an embodiment, the network entity may, e.g., be configured to transmit the validity timer to the user equipment by transmitting a suspendConfig or a RRCSuspend message which comprises the validity timer.

In an embodiment, the validity condition may, e.g., comprise an information which can be derived from a non-user-equipment-specific signaling channel, e.g., a broadcast channel or a channel addressing a group of user equipments.

According to an embodiment, the network entity may, e.g., be configured to transmit the first configuration information and the second configuration information to the user equipment. The first configuration information for transmitting the reference signal for positioning during the first radio resource control state of the user equipment comprises a first transmission characteristics. The second configuration information for transmitting the reference signal for positioning during the second radio resource control state of the user equipment comprises a second transmission characteristics, being different from the first transmission characteristics.

In an embodiment, the network entity may, e.g., be configured to transmit, to the user equipment, a power configuration for one or more uplink reference signal resources or resource sets.

According to an embodiment, the network entity may, e.g., be configured to transmit, to the user equipment, a spatial filter and/or a beam direction for transmitting the reference signal for positioning in one or more uplink reference signal resources or resource sets.

In an embodiment, the network entity may, e.g., be configured to receive the first configuration information or a portion of the first configuration information and/or the second configuration information or a portion of the second configuration information from a LMF (e.g., a location management function or e.g., a location management server). And/or, the network entity may, e.g., be configured to negotiate with the LMF the first configuration information or a portion of the first configuration information and/or the second configuration information or a portion of the second configuration information.

According to an embodiment, the network entity may, e.g., be configured to receive from the LMF information which configuration parameters are same within an area and what values they should use. And/or, the network entity may, e.g., be configured to negotiate with the LMF which configuration parameters are same within an area and what values they should use.

In an embodiment, the network entity may, e.g., be configured to receive from the LMF information which configuration parameters are orthogonal within two or more areas that are a subset of a larger area and what values they should use. And/or, the network entity may, e.g., be configured to negotiate with the LMF which are orthogonal within two or more areas that are a subset of a larger area and what values they should use.

According to an embodiment, the network entity may, e.g., be configured to receive from the LMF information which of the configuration parameters, if any, shall be determined by the user equipment (for example, by information available or signaled to the user equipment). And/or, the network entity may, e.g., be configured to negotiate with the LMF which of the configuration parameters, if any, shall be determined by the user equipment (for example, by information available or signaled to the user equipment).

For example, the LMF may signal the NG-RAN nodes within a positioning system area to use a certain slot and frame (an example of a same parameter). Or, the NG-RAN nodes may, e.g., interact with each other and/or with LMF to determine which slot and frame could be used within the positioning system area. This information could also be configured and signaled using the operation and maintenance interface. Likewise, the could determine (e.g. comb offset) as orthogonal configuration among some cells in the LMF—e.g. all cells use (PCI mod transmission Comb number) as comb_offset. Furthermore, some parameters such as SRS sequence may be determined by the UE based on certain ID.

Furthermore, a system according to an embodiment is provided. The system comprises a user equipment according to one of the above-described embodiments and a network entity according to one of the above-described embodiments.

The network entity is configured to transmit configuration information to the user equipment, wherein the configuration information is suitable to configure the user equipment for transmitting and/or for receiving a reference signal for positioning during the second radio resource control state of the user equipment.

The user equipment is configured to transmit and/or to receive the reference signal for positioning depending on the configuration information during the second radio resource control state of the user equipment.

In the following, some explanations to obtain a better understanding for embodiments of the present invention are provided.

A UE is assigned different states, from different points of view—registration management (RM-REGISTERED or RM-DEREGISTERED), connection management (CM-IDLE or CM-CONNECTED) and from radio resource control (RRC-IDLE, RRC-INACTIVE or RRC-CONNECTED).

In particular, the UE states RRC-IDLE, RRC-INACTIVE and RRC-CONNECTED are defined to achieve different goals. The state RRC-CONNECTED is an example of a connected state, where full connectivity between the core network and the UE is maintained. The state RRC-IDLE is an example of the idle state, where the UE monitors minimum channels, such as paging channel and/or system information. According to Rel. 16, the NG-RAN node releases the UE context when the UE moves to the idle mode. Hence, the UE context needs to be re-established at the NG-RAN side. This procedure causes high latency and signaling overhead if there are frequent state transitions. Therefore, an intermediate state between full connectivity (e.g. RRC-CONNECTED) and idle state (e.g. RRC-IDLE), an intermediate RRC state was introduced, called RRC-INACTIVE.

In Rel. 16, the RRC-INACTIVE allowed faster connection reestablishment because the UE-context was stored at the UE and/or the NG-RAN node. In particular, the signaling interface between the NG-RAN node and the AMF (the N2 interface) was not torn down in RRC-INACTIVE, as opposed to RRC-IDLE where the UE context was released and reestablished on subsequent RRC-CONNECTION setup.

In Rel. 16, a UE in RRC-INACTIVE supports monitoring of system information (SI) messages, paging channel. It may request SI (if configured) and perform RAN-based notification area updates (RNA-U). Unicast data and/or reference signals transmission in uplink and/or unicast signaling (e.g. using SRB1, SRB2) are not foreseen in Rel. 16. A Rel. 17 UE in RRC-INACTIVE state is envisioned to support limited data transmission and/or reception and/or some reference transmission. The feature to enable the limited data and signaling exchanges is called small data transmission (SDT), which is subject to further discussions and standardization.

According to embodiments of the invention, the UE may transmit optionally a reference signal in uplink to allow localization of the UE during the inactive state (e.g. the RRC_INACTIVE state).

A UE in an inactive state (e.g. RRC-INACTIVE) state may be able to transmit and receive limited data and/or control signaling without necessarily having to switch to a full connectivity state (e.g. RRC-CONNECTED).

According to embodiments of the invention, transmitting at least one uplink reference signal (e.g. PRACH, SRS, SRS for positioning etc) during the inactive state (e.g. RRC-INACTIVE) without necessarily having to switch to a full connectivity state (e.g. RRC-CONNECTED) is realized.

In this light, the term RRC-INACTIVE may also be construed to also mean an RRC-STATE where the UE has reduced reception and transmission capabilities compared to the RRC-STATE characterized by full connectivity (e.g the RRC-CONNECTED state).

One of the key reasons why different UE states are introduced by the 5G standard is to possibly reduce power consumption and/or optimise the amount of signaling and control data different UE states. In the RRC_INACTIVE state and RRC_IDLE states the UE decodes typically a minimum set of broadcast channels (e.g. PBCH) to maintain the synchronization and to receive paging signals.

According to Rel. 16 of the RRC specification, SRS is discontinued when the UE goes into RRC_INACTIVE or RRC_IDLE state or due to handover. This ensures that the UE does not generate unwanted interference in the RRC_INACTIVE or RRC_IDLE state. For uplink positioning, the SRS needs to be continued in RRC_INACTIVE and/or in RRC_IDLE.

If the SRS transmissions are continued other means must be found ensuring that the transmitted SRS do not generate unwanted interference or are configured in a way that the related gNBs can receive the signal. For moving devices the context (and the related configuration may change).

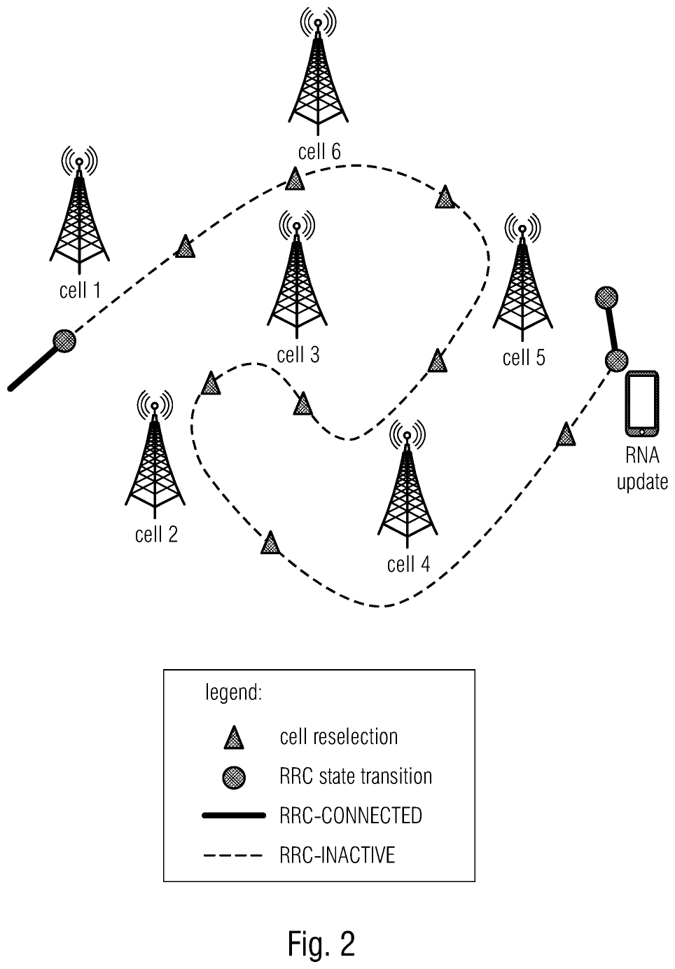

FIG. 2 illustrates a mobility of a UE and example RRC state transitions.

In the following, a brief description of UE states in a Rel. 16 UE in a 3GPP system using NR is provided, for explaining the background behind this invention in a non-limiting sense.

A UE in a 5G system is in two states from a registration management (RM) point of view, RM-DEREGISTERED and RM-REGISTERED. In the RM-DEREGISTERED state, the UE has not yet registered with the network and the AMF has no information on how it can reach the UE. A UE in a RM-DEREGISTERED state attempts to move to RM-REGISTERED state to receive a service that requires registration. When the UE is registered with the network, it periodically providers a periodic registration update procedure to notify the network that the UE is still active. If the UE moves away from the current tracking area identifier (TAI), then it does a Mobility Registration Update procedure to enable the AMF to page the UE.

From connection management (CM) point of view, the UE is either in CM-IDLE and CM-CONNECTED. CM-IDLE means the UE has no active signalling connection to the AMF (i.e. the AMF needs to page the UE within at least a cell in a tracking area to reach out to the UE). When the UE has not registered with the network, the UE attempts to move to CM-CONNECTED by performing Registration Request. When the UE has registered with the network, and the UE is in CM-IDLE state, then the UE sends a Service Request to move to CM-CONNECTED state or the network pages the UE to trigger UE procedures to move the UE to the CM-CONNECTED state.

From the radio resource control (RRC) point of view, the UE is either in RRC_IDLE, RRC_INACTIVE or RRC_CONNECTED state. In the RRC_IDLE state, there is no N1 or N2 signalling connection between the UE and the AMF. In the RRC_INACTIVE state, the N2 connection is maintained but the RRC_CONNECTION is suspended. In the RRC_CONNECTED state, full data and signaling connectivity between the 5GC network and the UE is established, and at least the signaling bearers SRB0, SRB1, SRB2 and possibly also SRB3 are established. However, in the RRC_INACTIVE state or in the RRC_IDLE state, only the signal bearer SRB0 remains active, while the remaining signal bearers are suspended for the UE. Thus, procedures that require an update of certain parameters to be provided to the UE, for example, dependent on changing locations of the UE within the network, require the UE to be in the RRC_CONNECTED mode.

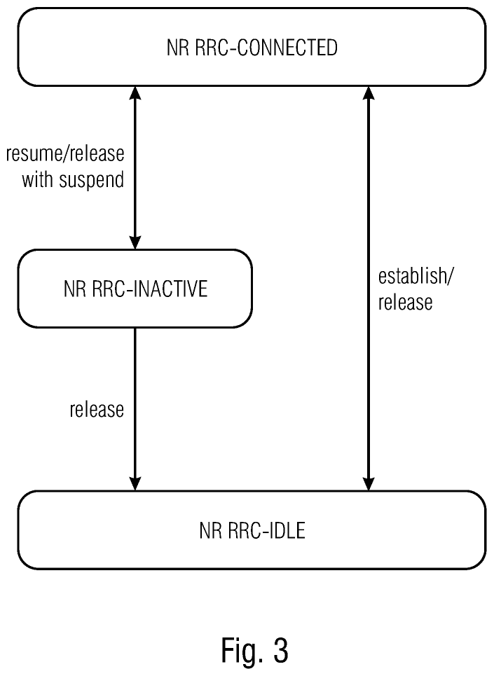

FIG. 3 illustrates a transition between different RRC states in NR. In particular, FIG. 3 illustrates a RRC State transition according to 38.331 for NR.

Depending on what the UE is allowed to transmit, the following two types of transmission from UE can be distinguished:

Regarding a contention free transmission, the UE transmits only in the resources the UE is assigned exclusively. Collision is avoided by multiplexing users in time and/or frequency and/or code. Examples of such transmission are: PUSCH, PUCCH, Contention-free RACH.

Regarding a transmission with contention, the UE transmission may collide with that from another UE. For example, see a transmission of the PRACH preamble or in some cases Message 3.

In Rel. 16, a UE cannot report measurements for positioning when it is in RRC_INACTIVE or RRC_IDLE state. Furthermore, a UE can also not transmit SRS when the UE moves to RRC_INACTIVE or RRC_IDLE state. Furthermore, upon handover, the UE also needs to stop transmitting SRS until it is reconfigured by the new cell. The aim of Rel. 16 is to enable the UE to report measurement while it is still in RRC_INACTIVE state by using the small data transmission feature. The small data transmission, is a new feature which is under discussion in 3GPP RAN working groups, which is envisaged to use the features like the random access and configured grant in uplink to enable data transfer. The exact mechanism of SDT is not standardized. Hence, SDT is mentioned in this invention to refer to an alternate and/or potentially lightweight mechanism of transferring signaling to the UE in a state other than RRC-CONNECTED.

For enabling transmission of SRS in the uplink, this invention describes the mechanism of providing configuration for RRC transmission in the RRC_INACTIVE and/or RRC_IDLE mode. Furthermore, it deals issues with triggering the start and stopping the transmissions. Moreover, it addresses the issue of timing advance adjustment and power control adjustments.

If the RRC_INACTIVE SRS transmission is not enabled, the transition to RRC_CONNECTED procedure may cause a high overhead on latency and power consumption. Therefore, this invention describes enhancements, that optimize power and latency. The use cases include among others, the devices that need continuous tracking and maintain a long battery life.

In the following, uplink reference signals (UL_RSs) are considered.

Uplink Reference Signals, such as SRS described herein as reference signals transmitted from an apparatus being a UE or a reference device or the like. UL-RS(s) may be referred to those skilled in the art as UL-PRS, SRS-for-positioning or any uplink or sidelink reference signal used for the purpose of positioning.

The UL reference signals are transmitted by a UE or a reference device and may be a dedicated positioning reference signal such UL-PRS or SRS-for-positioning or a communication reference signal used for the purpose of positioning such as SRS-for-MIMO. The configuration of the UL-PRS or SRS resource set and resources are determined by the higher layer configuration over a higher interface such as LPP from the LMF or possibly from a serving cell over an RRC or MAC-CE or DCI interface.

An SRS Resource Set is defined as a set of SRS resources where each Resource has a SRS Resource ID and can comprise one or more of the following:
SRS Configuration: List of Resources and Resource Sets to be added or removed
The maximum number of SRS resources per set for positioning (N).
The maximum number of supported SRS resource sets for positioning is a UE capability, with configurability of up to N resource sets per bandwidth part (BWP)
SRS resources list within the Set
Triggering Types for resources within a Set (Periodic, SP: Semi-Persistent, Aperiodic)
SRS Power Control parameters including the Alpha and PO value as well as the reference signal used path loss determination

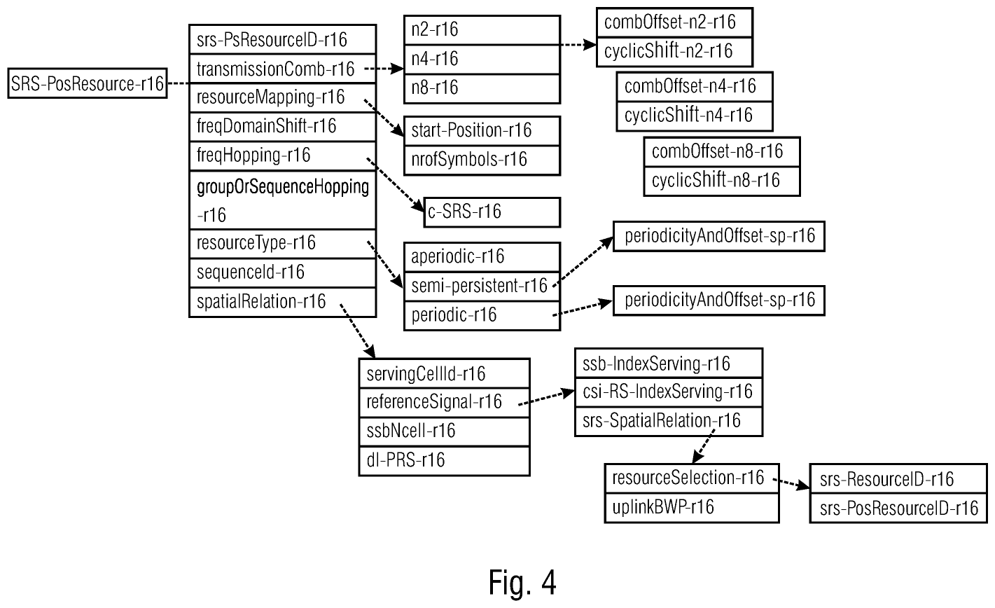

An example on the resource IEs for SRS are provided in FIG. 4.

In particular, FIG. 4 illustrates an example for a SRS-Position resource release 16 configuration.

FIG. 5 illustrates an example for positioning Resource Set RRC Messages.

In Positioning SRS-Resource release 16, the configuration entity (serving gNB or LMF) configures the UE for a transmission configuration on one or more UL-PRS, or SRS or SL-PRS resources. The configuration entity provides the UE with a high layer configuration message which includes assistance information on the UL-PRS (or SRS) resources received from one or more TRPs. The assistance information for the UL-PRS may include one or more of the following information SRS-ResourceSetId, SRS-ResourceId, UL BWP ID, Serving cell ID, PCI of the cell, ssbFrequencyhalfFramelndex, SSB-periodicity, ssbSubcarrierSpacing, SFN-SSBoffset, SMTC, SSB Index, SFN0 Offset, ss-PBCH-BlockPower ID, DL-PRS-ResourceSetId, DL-PRS-ResourceId, NZP-CSIRS-ResourceID, servingCellId. The configuration entity may be an entity at the core network (like an LMF) or a serving Base Station serving a UE.

The configuration entity provides or updates the UE with UL-PRS configuration which are indicated as IEs (Information Elements) over a higher layer interface like LPP for the case the configuration entity being an LMF or one of the following RRC, MAC-CE, DCI for the case the configuration entity being an Base Station or PC5 (Sidelink) interface for the case the configuration entity being an UE.

In the following, a general definition of a spatial filter is provided.

A spatial domain filter is referred to the digital, analog or hybrid transmit or receive antenna array architecture to generate a single or multiple transmitting or receiving beams. The transmitting beam(s) is generated by the spatial transmission filter whereas the receiving beam(s) is generated by the spatial reception filter.

In the following, a general overview over some of the embodiments is provided.

In some embodiments one or more SRS resources or resource set configurations are provided to the UE. This is already supported by the standard, but the methods to activate/deactivate a resource set is extended.

In some embodiments, one or more of the following concepts may, e.g., be employed.

For example in an embodiment, a set of conditions (e.g. quality of signals) is associated to a set. If the condition is fulfilled the UE can transmit the related SRS resource or SRS resource set. An example may, e.g., be the signal strength of the SSB.

According to an embodiment, additional identifiers may, e.g., be employed. For example, an area identifier is associated to a SRS resource and if the area identifier is received the related SRS resource is selected. The area identifier may be a cell-ID, for example, or a complementary area identifier included in a broadcast channel.

In an embodiment, trigger signals may, e.g., be transmitted over broadcast channels. The trigger signals may be UE specific or may address a group of UE or all UEs in a cell configured with the related SRS resource set. Hence, the trigger signal may include a identifier selecting the resource set.

Instead of using trigger signals for activation of the SRS transmission after receiving the configuration, according to an embodiment, the SRS configuration may, for example, be performed in two parts:

The first part may, e.g., be configured during the RRC_CONNECTED state and may include many parameters.

The remaining parameter (or parameters) may, e.g., be send using a second message. This second message may, e.g., complete the SRS configuration and defines the start (or stop=remove parameter from list of valid parameters) of the SRS transmission.

In an embodiment, two mechanisms are considered to stop a SRS transmission:

Similar to a trigger (enable signal) a disable signal is sent.

The trigger starts a timer and if on re-trigger is received the UE automatically stops when the timer expires.

According to an embodiment, instead of using broadcast channels the SDT mechanisms can be used to send the enable/disable signals or part 2 of the configuration message. This concept shall improve a reduction of the number of time intervals in which the UE has to return to the RRC_CONNECTED state.

Enable/disable signals are by unicast signaling to UE as of Rel. 16,
e.g., periodic after receiving the RRCReconfiguration
e.g., semi-persistent by MAC-CE
e.g., aperiodic by DCI.

In an embodiment, some RRC parameters for SRS may, e.g., be sent via SDT, or the triggers may, e.g., be sent via the SDT.

In an embodiment, the overhead related to the SRS configuration is reduced. For example, in an embodiment the amount of data to be transmitted over “more expensive” channels (=channels with lower efficiency) may e.g., be reduced.

In the following, embodiments are described, wherein the UE may, e.g., be provided with assistance data to transmit UL-PRS signal.

For example, a UE receives configuration for transmitting the UL-PRS in RRC_INACTIVE and/or RRC_IDLE, which may be different from the UL-PRS configuration in the RRC_CONNECTED state. Associated with the UL-PRS configuration is the validity area and/or validity timer. If the validity timer for the SRS expires, the UE shall stop transmitting the SRS.

The configuration and desired UE SRS transmission characteristics can be different in the idle and inactive states compared to the connected state. Compared to connected state, the SRS inactive or idle configuration may need to be adjusted for enhancing coverage, reducing UE power consumption or reducing network interference.

In one aspect, the UE can receive an SRS configuration comprising an indication on the state validity {connected, inactive, idle} of an SRS resource(s) or resource set(s) configuration.

In one option, a network entity, NW, [e.g. gNB or LMF] configures the UE with one or more SRS configurations over a first interface [e.g. RRC] when the UE is in an RRC connected state. The network entity can configure the UE over a second interface during the inactive or idle state to update at least one parameter or transmission setting in the RRC SRS configuration. Examples of the second interface can be posSIB, SI (system information, SDT/R (small data transmission/reception), paging or the like.

In another option, a network entity, NW, (e.g. gNB or LMF) configures the UE with one or more SRS configurations over an interface (e.g. system information, positioning system information) during an inactive or idle state.

In the connected state, one or more configurations may, e.g., be provided.

For example, if there are more than one configurations provided, then the one that is to be activated may, e.g., depend on a signaling of configuration ID (e.g. using SDT/R, SI, posSib, SI, etc), and/or may, e.g., depend on measurements (outcome of measurement is an event, and an event may, e.g., trigger a particular configuration).

The UE may receive such configuration as system information broadcast (e.g. posSib) or from the small data transmission mechanism (e.g. the UE sends the SRS request over the SDT mechanism), which the UE uses for transmitting SRS during the RRC INACTIVE and RRC_IDLE state.

In a third option, The UE may receive an indication to switch to the connected state in case a new SRS configuration is to be provided or the configured parameters are no longer valid.

The UE may be required to update configuration from the second interface (for example, posSib). Over the second interface an identifier may be transmitted selecting a predefined configuration. If the identifier matches the provided configuration, it may continue transmitting. In one aspect, the SRS configuration provided to the UE by the NW entity for use in the RRC_INACTIVE state or RRC_IDLE states are coordinated among the NG-RAN nodes within an area. The area may be a cell, a portion of the cell, a group of cells, a RAN notification area, a positioning system information area, a system information area or a tracking area. The coordination may be done by the LMF and/or a group of NG-RAN nodes. Alternatively, the exchange of configurations to be provided to the UEs may be carried out among the NG-RAN nodes within the area where the RRC_INACTIVE or RRC_IDLE transmission are coordinated by the network. As a third alternative, the set of configurations allowed for the UE in RRC_IDLE and RRC_INACTIVE may be coordinated by means of O&M mechanism.

One possible mechanism of exchanging suitable configuration may, e.g., involve handshaking procedure between two or more nodes. As an example: the LMF may suggest one or more configuration to a set of NG-RAN nodes. Alternatively, a NG-RAN node may initiate the configuration suggestion step to other NG-RAN nodes. In both variants, the leading node (NG-RAN node or the LMF) receive configuration confirmation and/or alternative configuration or rejection with alternative configuration. The leading node may, e.g., determine whether a common configuration is available and if it exists, then it triggers an activation command to each NG-RAN node that confirmed this configuration to use this configuration. If not, then it begins with a new set of recommendation.

For the common configuration/common parameters for a configuration, the NG-RAN nodes and/or the CN nodes may, e.g., interact with each other to determine the common parameters applicable to area. The common parameters may, e.g., be stored by at least one NG-RAN node and provided to the UE. The common parameters that are applicable may, e.g., be coordinated among one or more cells served by one or more NG-RAN nodes. The exchange may, e.g., be via any interfaces connecting two NG-RAN nodes (e.g., the X2 interface) or interface connecting a NG-RAN node to a core network element (e.g. AMF) using standard interace such as NG interface (NG-AP), or NRPPa or any other O&M interfaces.

The dedicated parameter may, e.g., be provided by SDT or computed by the UE based on some measurement or logical information or based on some UE identifiers.

In an embodiment, the NW (network) may, e.g., configure at least one configuration to be used by the UEs in RRC_INACTIVE or RRC_IDLE state. Part of the configuration would be common to all the UEs using this configuration and this can be signaled to the UE either by broadcast of system information and/or by unicast and/or multicast and/or groupcast.

This configuration may, e.g., have a validity of an area identifier (e.g. system information area, positioning system information area, a RNA, a group of cells) instead of validity only in serving cell.

In an alternative embodiment, the method the NG-RSN may, e.g., directly exchange information between the NG-RAN nodes.

The remainder of the parameters used by the UE may, e.g., either signaled to the UE by the network with unicast signaling or are derived by the UE based on UE-Identity. The UE-Identify may be any of the 5G-S-TMSI, I-RNTI.

For example the SRS sequence may be based on the I-RNTI or 5G-TMSI and/or

A cyclic shift and/or comb offset may, e.g., be derived based on last known PCI where the UE was detached.

The SRS transmission from the UEs may, for example, be orthogonalised by configuring orthogonal resources, such as comb offset, comb factor, periodicity and offset, slot, cyclic shift, sequence ID and so forth. In case of Rel. 16, the NG-RAN node can coordinate so that the UEs in the same cell have orthogonal parameters. However, in case of RRC_INACTIVE UEs, when the UEs move within the RNA, the positioning SRS from the first UE could collide with the positioning SRS from the second UE. To reduce the likelihood of collisions, some of the orthogonal parameters may be derived based on UE-identifiers and/or based on the identifier of the NW entity the UE was connected to. As an example, the root sequence ID of the Zadoff-Chu sequence and/or the cyclic shift may be derived from UE identifiers such as C-RNTI in the previous cell, temporary UE IDs such as 5G-TMSI. Likewise, some other parameters, such as comb-offset could be determined based on the serving cell that last assigned or updated the SRS configuration or the cell where the UE performed the last RNA-update.

For example: k_offset=(CellID_{lastcell}_mode K_TC), or k_offset=(CellID_{lastcell} mod K_TC), or k_offset=Mod(CellID_{lastcell}, K_TC), where CellID_{lastcell} is the identifier of the cell where the SRS was last updated or where RNA-update was last carried out. The cell-ID could be the PCI or NR-CGI, as examples. (Mod is the Modulo operator)

When the UE is configured with more than one configuration by the network, which the UE is supposed to use during RRC_INACTIVE or RRC_IDLE states, then the network may, e.g., also provide the selection configuration to select at least one set of the uplink positioning reference signal configuration for transmission.

In an embodiment, the configuration received by the UE may, e.g., have an ‘area identifier’ where the configuration is valid and a version of the configuration valid within the area identifier. This information could be part of broadcast of the cell allowing transmission of UL positioning signal in RRC_INACTIVE and RRC_IDLE mode. If the ‘area identifier’ and the ‘version’ of the configuration matches the configuration stored in the UE, then the UE may continue transmission of UL positioning signal without transitioning to the RRC_CONNECTED state. The cell could specify the “area identifier” and the version of signal configuration for uplink positioning slot within the positioning SIB.

According to an embodiment, when the UE receives the configuration, it may have some information telling the, ‘validity area’ and a version of this configuration information within this ‘validity area’. There may be some information from the network (e.g. via SI), which area does the current cell belong to and what version of the configuration the cell is using. If the version stored by the UE and the version of configuration for idle/inactive mode used by the network match, then the configuration stored by the UE is valid for use. Otherwise, the UE needs to acquire new configuration before transmitting.

If the UE is not allowed to transmit uplink positioning reference signal in RRC_IDLE and RRC_INACTIVE while camped within this cell, then, for example, either the configuration of uplink positioning signal for RRC_IDLE and RRC_INACTIVE may not be broadcasted by the cell or the cell may signal explicitly the UE that only the UEs that are in RRC_CONNECTED state may transmit SRS for positioning. In this case, the UE may inform the LMF about the cell it is currently camped in. The UE then may be reconfigured to use different positioning method, such as DL-TDOA, DL-ECID, GNSS. OTDOA in RRC_INACTIVE mode, or the NW entity may configure the UE to use one of the positioning methods available in RRC_CONNECTED state. To this end, the NW pages the UE to initiate the new positioning methods. Alternatively, the LMF may signal the gNB to move the UE to RRC_CONNECTED state and request RRC resume. (Put in SRS request (as in Rel. 16)). As a result, the RRC_Resume only concerns positioning, the path-switch is not done.

If the UE has more than one configuration configured for a UE, and the current camped cell also allows at least one of the configurations, then the UE may, for example, select at least one configuration from the set of available the configuration and transmit using this configuration. The selection may be based on selection rules on validity and priority as configured by the network or alternatively it may be selected arbitrarily by the UE. The network may update the UE to a different configuration.

According to an embodiment, a UE may, for example, receive a signaling indicating that the SRS configuration provided for the RRC_CONNECTED is also valid for RRC_INACTIVE and/or RRC_IDLE state. The signaling may add a validity area and a validity timer before moving the UE into RRC_INACTIVE state. The UE continues to transmit the uplink positioning signal, as long as this configuration has its validity. When the validity expires or the UE has moved away from the area indicated by the validity area, then the UE may transmit in one of the resources provided in the broadcast of system information, and then either receiving the remainder of the parameters or deriving the remaining parameters based on UE-identity.

The signaling may, for example, be added as a part of suspendConfig IE during the RRC_Suspend message.

The configuration for uplink positioning signal may, for example, be used for uplink positioning may be updated during the periodic RAN updates.

According to an embodiment, the UE may, for example, be provided configuration parameters for SRS transmission and the network indicates that at least one parameter which needs to be updated in a new area if the SRS transmission is to be continued in this area. When the UE moves from the first area to a second area, if it receives a message which updates this parameter, then the UE may continue transmission. Otherwise, the UE needs to stop transmission of the SRS. The area in this scope could include, a cell, a group of cells, a positioning system information area, a portion of cell, a RNA notification area, a system information area or a tracking area.

According to an embodiment, the network may, e.g., provide a list of configuration parameters where at least one parameter necessary for transmitting SRS is not signaled to the UE during the initial configuration. When the UE receives the parameter or other parameter to derive the missing parameter while it is in RRC_INACTIVE state, then the UE begins transmission of a periodic SRS in INACTIVE and/or in IDLE mode. When the UE moves into another area, if the parameter or other parameters to derive the missing parameter is provided, then the UE continues transmission otherwise, the UE stops the periodic transmission. In line with this embodiment, the parameter could be signaled as a parameter that needs to be released if the message providing this parameter does not have this IE as one of the fields, this indicates the UE that the parameter needs to be released. Since the UE now does not have complete list of configuration parameters, the UE stops the transmission.

In an embodiment, an SRS request when RNA-Update or TAC-update may, e.g., be conducted, if the UE moves outside an area (RNA-Area) For example, if a UE moves outside the RNA or outside the TAC area where the UE has received the SRS configuration, it may, for example, be required as a fallback to stop transmitting the SRS and acquire configuration newly in this cell. The request for an updated SRS configuration for positioning may be made during the RAN update or the TAC update.

In the following, it is considered how to maintain synchronization and the power control spatial relation.

For power control, there are three relevant RRC parameters.

The target receive power is given by: (PO) This is the power that would be received at TRP if there were 0 dB path loss between UE and TRP.

Fractional power control (alpha) Absence means 1 (full pathloss compensation).

Pathloss reference signal which in turn controls the estimate of the pathloss between the UE and the entity (e.g. TRP) transmitting the pathloss reference signal.

If the UE in the inactive or idle state cannot determine a configured pathloss reference signal, the UE may, for example, use the SSB used for decoding MIB as a default pathloss reference signal.

The UE may, for example, be provided with configuration rules mapping certain UE measurements to synchronization and/or power control settings by the network.

In accordance with embodiments, the user equipment may, for example, conduct one or more of the following steps:

Receiving a message from a network entity, comprising one or more configuration(s) for the reception of one or more UL-RS(s) associated with the UE inactive or idle state.

Receiving from the network entity, [gNB], an indication including a power configuration for one or more SRS resource set(s).

Determining the transmit power in the inactive or idle states for the one or more SRS resources in an SRS resource set.

With respect to the spatial relation, in an embodiment, a UE may for example, be configured to transmit a SRS during the RRC_CONNECTED state in the normal uplink, and the UE may, for example, be configured with a second SRS configuration for transmitting positioning SRS during RRC_INACTIVE or RRC_IDLE state in a supplementary uplink carrier configured for this UE.

When the UE moves to RRC_INACTIVE or RRC_IDLE, the UE may, e.g., switch from transmitting positioning SRS in the normal uplink to transmitting positioning SRS in the supplementary uplink. State transition back to RRC_CONNECTED then stops the SRS transmission back to the normal uplink carrier.

According to some embodiments, supplementary uplink configuration (usually in FR1) may, for example, be employed for avoiding spatial filter adjustment issues for the UE.

In an embodiment, the SRS configuration(s) may, e.g., comprise at least one or more identifier(s), ID(s), of one or more other SRS resource(s) or DL RS resources to indicate at least a spatial filter or beam direction for the transmission of the one or more SRS resource(s) in inactive state. In an alternative, the SRS configuration may not include a spatial relation field to indicate the UE to apply beamsweeping on the plurality of SRS resources.

In accordance with embodiments, a method performed by the user equipment, UE, is provided, wherein the method comprises:

Receiving a message from a network entity, comprising one or more configuration(s) for the reception of one or more UL-RS(s) associated with the UE inactive or idle state.

Receiving from the network entity, [gNB], an indication including a transmit spatial filter information for one or more SRS resource(s). And:

Determining the transmit spatial filter(s) or beam direction(s) in the inactive or idle states for the one or more SRS resource(s).

According to an embodiment, a mapping table between a downlink reference signal, the UE is expected to measure, and a corresponding setting for timing advance, TA, may be provided by the network.

1) Receiving configuration from the network, the configuration may, e.g., include the information related to the downlink reference signal.

2) The UE may, e.g., perform the measurement on one or more downlink reference signals from the provided configuration.

3) Based on the measurement values and the information in the received configuration, the UE may, e.g., update one or more parameters without the need of explicit update command from the network.

The received configuration may, e.g., provide information that the UE may, e.g., use to map the measurement to a value of a parameter and/or the UE uses to combine one or more of these parameters to compute such parameter at the UE side.

In one example, the TA may, e.g., be a parameter that is updated by the UE without explicit signalling from the network.

In another example, the transmit power may, e.g., be a parameter that is updated by the UE without explicit signalling from the network.

In a third example, the transmit or receive spatial filter may, e.g., be a parameter that updated by the UE without explicit signalling from the network.

The network may, for example, provide correction of the TA to the UE using paging or during one of the configured resources for short data that the UE may be configured to monitor in inactive state.

The UE may, e.g., be expected to measure one or more downlink reference signal (such as DL-PRS and/or PSS or SSS within a SSB and/or DL CSI-RS). The measurement quantity may, e.g., be one or more of the following:
RSRP
time of arrival
time difference of arrival between two DL reference signals.

The measurement obtained may, e.g., be used to obtain timing advance (for example, using a mapping).

In a related example below, a UE may, e.g., be configured to monitor RSRP on a DL-PRS (for example, DL-PRS with ID=1 in this example). The UE may, e.g., determine the RSRP value, and based on this RSRP value may, e.g., decide whether to increase or decrease the timing advance value the UE was previously configured (for example, in the RRC_CONNECTED state). If the RSRP value exceeds a certain value beyond which the provided mapping cannot be used further, then the UE may, e.g., be signaled and/or may, e.g., be configured to stop transmitting the uplink positioning signal in uplink.

| | Measurement | | Corresponding |
|---|---|---|---|
| DL-RS | Quantity | Value range [dBm] | TA setting |
| DL-PRS | RSRP | RSRP < −120 | STOP |
| (id = 1) | | | |
| DL-PRS | RSRP | −120 < RSRP < −100 | +1 Ts |
| (id = 1) | | | |
| DL-PRS | RSRP | −100 < RSRP < −80 | 0 |
| (id = 1) | | | |
| DL-PRS | RSRP | −80 < RSRP < −60 | −1 Ts |
| (id = 1) | | | |
| DL-PRS | RSRP | RSRP > −60 | STOP |
| (id = 1) | | | |

The UE may, e.g., simply be provided a value range of measurement, where the UE is expected to maintain its current timing advance, and when this value range is violated, then the UE may, e.g., be configured/signalling to stop the transmission of uplink reference signal in the RRC_INACTIVE state.

A UE may, e.g., be configured to monitor one or more resources simultaneously. For example, a UE may, e.g., be configured to monitor DL-PRS (id=1) and DL-PRS (id=2) on a certain physical quantity (e.g. RSRP and/or time of arrival and/or time difference of arrival). The corresponding TA setting could be signaled as a combination of two measurements. For example, use a TA setting of 0 (no change) if the RSRP measured on DL-PRS (id=1) is within −100 dBm<RSRP<−80 dBm and RSRP measured on DL-PRS (id=2) RSRP>−80 dBm. The condition that a certain measurement lies in a certain value range for a DL-RS, and the condition that a certain measurement lies in a certain second value range for a second DL-RS could be combined together using any binary or u-nary logical operation (e.g. OR, AND, NOT, XOR . . . etc.) and the combination of such conditions could map to a certain TA setting. Alternatively, the network entity provides UE a model to combine measurement of two or more physical quantities made on one or more downlink reference signals. The UE makes measurement on one or more of the said downlink reference signals and uses the measurement according to the provided model to deduce the TA value to use for transmission and/or refrain from transmission. The network entity may use UE measurements and TA used by UE to learn the model applicable to a certain area in the network. Such model may also be used to deduce other transmission parameters such as transmit power and spatial relation.

Furthermore, the measurement may, e.g., refer to the absolute measurements made at the measurement instant. For example, a RSRP measurement and/or a timing measurement. Alternatively, the measurement may, e.g., refer to the relative measurement made at the measurement instant with respect to the measurement made during a reference time. The measurement made during a reference time may, e.g., refer to the last measurement made while the UE was in the RRC_CONNECTED. The difference in measurement between the RRC_CONNECTED state, and the measurement in the RRC_INACTIVE measurement may, e.g., then refer to as the relative measurement. Such measurement quantities may, e.g., be signal power, timing difference, etc. Similar to the absolute case, the measurements from one or more DL-RS may, e.g., be combined to map to timing advance.

The two DL-RS that a UE may, e.g., be expected to measure may, e.g., be indicated to the UE by providing information, so that the UE may, e.g., uniquely map to a certain transmission. The information that the UE may be provided and/or may, e.g., infer from measurements for identifying a certain DL-PRS may be any of the following:
DL-PRS Resource Set Id
DL-PRS Resource ID
ARFCN
Global cell ID
Area ID.

According to an embodiment, a UE may, e.g., select a configuration from a set of configuration available to a group of UEs to select from. For example, the UE may, e.g., select a configuration from a set of configuration available to a UE when it is camped in a cell. The UE may simply signal the configuration index. Or, the UE uses the SDT to inform the LMF of the configuration it used. Regarding the mechanism for sending the configuration used by the UE in RRC-INACTIVE, the UE, using SDT, may, for example, send the UE specific parameter e.g. SRS sequence, cyclic shift using the SDT after sending the SRS.

The UE may, e.g., be provided with a UE-specific configuration before the RRC_Suspend is provided.

Moreover, the UE may, e.g., keep on using the configuration until cell-reselection occurs

Furthermore, the NG-RAN node may, e.g., page the UE if the configuration is changed.

Moreover, the UE may, e.g., have a configuration provided by the LMF valid for a certain area. The LMF simply asks the LMF to keep these resources aside for UEs in idle mode.

In the following, activation and deactivation of P-SRS and SP-PRS is considered.

For a UE configured with an SRS Periodic transmission, in some embodiments, the transmission cannot be activated in the Inactive state if configured in the RRC resource is provided in the connected state. If configured in the connected state, the UE may, e.g., start transmitting upon receiving the configuration. Hence the UE cannot be provided with a periodic SRS configuration in the connected state which the UE can activate in the inactive state.

According to a solution of an embodiment, the UE may, e.g., be provided with SRS resource or/and resource set configuration including an inactive (or idle state) indication. Depending on the indication, the UE will not activate the transmission unless it receives an activation command over the second interface received during the inactive or idle state.

In an alternative solution, the UE may, e.g., provided with SRS resource or/and resource set configuration before the UE switches in the inactive or idle state.

For a moving UE in the network the configured SRS configurations may, e.g., be deactivated after a handover between a source gNB and the target gNB. Unlike MIMO SRS, Positioning SRS is configured to be received by multiple TRPs which can be independent neighboring gNB or new serving gNB. For MIMO SRS and SRS positioning in Rel-16 the UE is configured to deactivate an SRS transmission by after a handover.

In one embodiment, a UE configured with an SRS for positioning in the inactive or idle state, shall not deactivate or abort the SRS transmission as long as the SRS positioning validity conditions are met. Wherein the condition for the positioning SRS validity can be provided with by an area identifier such a Positioning Area ID, Tracking area ID or Radio Area ID or the like. Wherein the condition for the positioning SRS validity can be provided with by an activity timer. Wherein the condition for the positioning SRS validity is dependent on the control information received by the UE during the inactive or idle states.

The area identifier may, for example, be one or more of the following:
the RAN notification area and/or the tracking area,
the system information area,
the positioning system information area,
the cell,
a certain part or portion of a cell, or a certain part or portion of the RAN notification area, or a part or a certain portion of the system information area or a part or a portion of the positioning system information area, each being denoted by an appropriate area identifier,
any combination of the above areas.

If the configuration is provided for an area and not a cell, the issue from handover should be solved within the area. In an embodiment, when a UE moves out of area, the UE may, e.g., read the posSib in new area, may, e.g., derive the UE configuration and may, e.g., continue transmitting SRS according to new configuration.

In the following, a procedure for uplink and downlink in inactive and/or idle states according to some embodiments is considered.

According to embodiments, a UE may, e.g., be configured in the inactive or idle state to perform DL and UL positioning procedure. The UE may, e.g., be configured in to measure a plurality of DL PRS resources from one or more TRPs. The network can provide the UE with an UL SRS configuration, wherein the parameters of the UL SRS configuration are dependent on the received DL-PRS resources.

In one example, the UE may, e.g., receive from a network entity (gNB or LMF) information on a polarity of DL-PRS resources or resource set configurations. The multiple DL-PRS resources or sets belonging to the same TRP, the UE can select one or more DL-PRS resources per TRP for configuring the Pathloss reference signal and/or the spatial filter. In contrast to the current standard approach, the UE is not explicitly configured with a specific DL-PRS parameter for spatial relation and/or pathloss determination.

In the following, UE capabilities are considered.

Different capability indications for different functionalities may e.g., be provided.

A capability transfer may, e.g., occur over a gNB or a LMF (location management function).

For example, an indication on the UE capability to receive an SRS configuration during an inactive/idle state may, e.g., be provided.

And/or an indication on the UE capability to receive an update on SRS configuration during an inactive/idle state may, e.g., be provided.

In the following, a UE initiated procedure is considered.

An SRS configuration may, e.g., be requested.

For example, a UE may request a serving or a camped cell to provide it a positioning SRS configuration, where at least one of the configuration parameter may be requested by the UE. The request for the SRS configuration may be sent using the SDT mechanism to the serving node, whereby the UE may specify the value of at least one of the parameters:

A selection of one bandwidth part from the list of BWP configured for the UE, such that the configuration pertaining to this BWP can be used if already available at the UE or it can be provided by the network.

Any of the parameters specified in Rel. 16 for SRS for characterizing positioning SRS. (such as transmission comb number, comb offset, etc.

The SRS transmission may, e.g., be requested on normal carrier or supplementary carrier.

The request may be sent directly to by the UE NG-RAN node or it may be sent to the LMF, which in turn sends the request to the NG-RAN node. The LMF may further send MEASURE_REQEUST to TRPs to make measurement with the requested configuration.

In the following, a measurement dependent procedure according to an embodiment is provided.

For example, a UE may, e.g., be configured with measurement and the outcome of the measurements are mapped to events.

A UE may, for example, be configured to begin transmitting or to stop transmitting an SRS configured for IDLE or INACTIVE mode when an event is triggered. example: For example, a UE may, e.g., be configured to make measurement on two cells, and event ‘Event A’ may be defined as the situation when the first cell is stronger than the second cell, and ‘Event B’ may be defined as the situation when the second cell is stronger than the first cell. The occurrence of ‘Event A’ may trigger the SRS transmission and the occurrence of ‘Event B’ may trigger the UE to stop the SRS transmissions.

In the following, a trigger of transmission by measurement may, e.g., be considered.

A UE may, for example, be configured to associate at least one DL-RS with at least one configuration of uplink reference signal. A UE may, e.g., be required to measure the associated DL-RS before transmitting a particular reference signal.

Depending on the outcome of the associated DL-RS, a UE may either transmit or avoid transmitting on a certain configuration of SRS based on the outcome:

For example, the UE may
Avoid transmitting using the configuration associated with the said DL-RS if the measured value is below a certain threshold value configured by the network.
Avoid transmitting using the configuration associated with the said DL-RS if the measured value is above a certain threshold value configured by the network.
Transmit using the configuration associated with the said DL-RS if the measured value is above a certain threshold value configured by the network.
Transmit using the configuration associated with the said DL-RS if the measured value is below a certain threshold value configured by the network.
Transmit using the configuration associated with the said DL-RS if the measured value is below a first threshold value configured by the network and above a second threshold value configured by the network.

If more than one configurations of SRS satisfy the configured rules, the UE may, e.g., be required to transmit on all of the resources, or it may be configured with some priority rules on which resources to transmit subject to UE capacity.

The measurement could be any of the timing measurements (such as ToA, RSTD, ToF), power measurements (RSRP, RSSI).

If measurement on more than one DL-RS map to a certain configuration of uplink reference signal, then the difference between the measurement made between two resources may, e.g., be the criteria for triggering the measurement. For example, if DL-PRS (id=1) and DL-PRS (id=2) are jointly associated to SRS configuration (id=1), and the criteria signaled by the network is that the RSTD between them is more than 100 ns but less than 200 ns, the SRS configuration (id=1) is triggered to transmit when the RSTD is above 100 ns and is triggered to stop transmitting when the RSTD is below 200 ns.

In another embodiment, a base station may, e.g., be configured to associate at least one uplink demodulation reference signal (UL-DMRS) with at least one configuration of a downlink reference signal. The base station may, e.g., need to measure an associated UL-DMRS before transmitted a particular reference signal.

Depending on the outcome of the associated UL-DMRS, a base station may, e.g., either transmit or avoid transmitting on a certain configuration of PRS based on the outcome.

In the following, further embodiments of the present invention are presented.

According to some embodiments, a method performed by a user equipment, and a user equipment configured to perform the method is provided, wherein the method comprises:

Providing a network entity with the one or more capabilities information, wherein at least one capability includes an indication support of transmitting one or more SRS resources or resource set(s) in an inactive state or an idle state.

Receiving from the network entity one or more SRS configuration(s) for one more SRS resources or resource sets.

And: Applying the SRS configuration to transmit the one or more SRS resources in an inactive state or an idle state

In some embodiments, with respect to SRS resource and resource set configuration, different configurations for an inactive and a connected state are provided.

In some embodiments, one or more network, NW, initiated procedures for SRS triggering, activation and de-activation procedures are provided, e.g.,
RRC release with suspend config
RRC inactive config
paging information monitoring and update
posSRS positioning area dependent
an actrivation/deactivation procedure e.g., for periodic resource configuration
a triggering procedure e.g., s-periodic resource configuration, and/or a-periodic resource configuration
a default configuration, for example, in case a DL-RS is not detected

According to embodiments, UE initiated procedures are provided.

In embodiments, uplink and/or downlink procedures are provided.

According to embodiments, a UE capability is provided.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

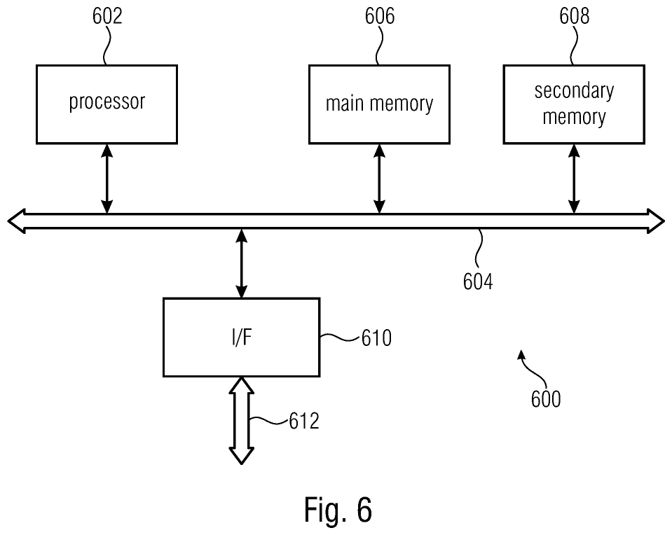

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 6 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

| | |
|---|---|
| RRC | TS38.331 v16.1.0 |
| LPP | TS37.355 v16.1.0 |
| NRPPa | TS38.455 v16.0.0 |

### Abbreviations

| Abbreviation | Definition |
|---|---|
| 3GPP | third generation partnership project |
| 5GC | 5G core network |
| BS | base station |
| CSI-RS | channel state information reference signal |
| DMRS | demodulation reference signal |
| DOA | direction of arrival |
| E-CID | enhanced cell ID |
| eNB | evolved node b |
| E-SMLC | evolved serving mobile location center. |
| E-UTRA | evolved UMTS terrestrial radio access |
| gNB | next generation node-b |
| GPS | Global Positioning System |
| LMF | location management function |
| LMU | location measurement unit |
| LPP | LTE positioning protocol |
| LTE | Long-term evolution |
| NG | next generation |
| ng-eNB | next generation eNB |
| NG-RAN | either a gNB or an ng-eNB |
| NR | new radio |
| NRPPa | new radio positioning protocol a |
| OTDOA | observe time difference of arrival |
| PRS | position reference signal |
| PTRS | phase tracking reference signal |
| QCL | quasi colocation |
| RAN | radio access network |
| RP | reception point |
| RSTD | reference signal time difference |
| RTOA | relative time of arrival |
| RTT | round trip time |
| SA | Standalone |
| SRS | sounding reference signal |
| TDM | Time Domain Multiplexing |
| TOF | time of flight |
| TRP | transmission reception point |
| RS | reference signal |
| QCL | quasi co-located |
| AoA | Angle of Arrival |
| AoD | Angle of Departure |
| PAS | Power Angular Spectrum |
| NR | New Radio |

1. A user equipment for transmitting and receiving data in a wireless communication system,
wherein, at a point-in-time, the user equipment is in one of a plurality of radio resource control (RRC) states,
wherein for each radio resource control state of at least a first radio resource control state and a second radio resource control state of the plurality of radio resource control states, when the user equipment is in said radio resource control state, the user equipment is configured to transmit and/or to receive a reference signal for positioning depending on configuration information received from a network entity of the wireless communication system.

2. The user equipment according to claim 1, wherein the user equipment is configured to begin to transmit or to stop to transmit the reference signal for positioning depending on whether or not an event is triggered.

3. The user equipment according to claim 2, wherein the user equipment is configured to stop to transmit the reference signal for positioning if it is triggered as the event that a timing advance cannot be validated.

4. The user equipment according to claim 2, wherein the user equipment is configured to stop to transmit the reference signal for positioning depending a Reference Signal Received Power for a downlink reference signal.

5. The user equipment according to claim 1,
wherein the user equipment is configured to measure a downlink reference signal,
wherein the user equipment is configured to transmit the reference signal for positioning depending on the measuring of the downlink reference signal.

6. The user equipment according to claim 5, wherein the user equipment is configured to apply one or more of the following rules:
avoid transmitting the reference signal for positioning using a configuration associated with the said downlink reference signal, if the measured value is below a certain threshold value configured by the network;
avoid transmitting the reference signal for positioning using the configuration associated with the said downlink reference signal, if the measured value is above a certain threshold value configured by the network;
transmit the reference signal for positioning using the configuration associated with the said downlink reference signal, if the measured value is above a certain threshold value configured by the network;
transmit the reference signal for positioning using the configuration associated with the said downlink reference signal, if the measured value is below a certain threshold value configured by the network;
transmit the reference signal for positioning using the configuration associated with the said downlink reference signal, if the measured value is below a first threshold value configured by the network and above a second threshold value configured by the network.

7. The user equipment according to claim 1, wherein the user equipment is configured to measure a downlink reference signal, wherein the user equipment is configured to transmit an uplink reference signal depending on the measuring of the downlink reference signal.

8. The user equipment according to claim 7, wherein the user equipment is configured to apply one or more of the following rules:
avoid transmitting the uplink reference signal using a configuration associated with the said downlink reference signal, if the measured value is below a certain threshold value configured by the network;
avoid transmitting the uplink reference signal using the configuration associated with the said downlink reference signal, if the measured value is above a certain threshold value configured by the network;
transmit the uplink reference signal using the configuration associated with the said downlink reference signal, if the measured value is above a certain threshold value configured by the network;
transmit the uplink reference signal using the configuration associated with the said downlink reference signal, if the measured value is below a certain threshold value configured by the network;
transmit the uplink reference signal using the configuration associated with the said downlink reference signal, if the measured value is below a first threshold value configured by the network and above a second threshold value configured by the network.

9. The user equipment according to claim 2, wherein the user equipment is configured to conduct the measurement of the downlink reference signal by conducting a timing measurement, for example, a ToA, or a RSTD, or a ToF, or by conducting a power measurement, for example, a RSRP, or a RSSI.

10. The user equipment according to claim 1,
wherein the user equipment is configured to receive and use an uplink reference signal resource configuration for transmitting the reference signal for positioning,
wherein, when the user equipment is in the second radio resource control state, the user equipment is configured to measure one or more downlink positioning reference signal resources from a base station,
wherein the uplink reference signal resource configuration is associated with the one or more downlink positioning reference signal resources.

11-16. (canceled)

17. The user equipment according to claim 1,
wherein, when the user equipment is in the first radio resource control state, the user equipment is configured with network controlled mobility, and
wherein, when the user equipment is in the second radio resource control state, the user equipment is configured with user equipment mobility which depends on a network configuration.

18-22. (canceled)

23. The user equipment according to claim 21,
wherein the first configuration information comprises a first resource (ID) identifier identifying a reference signal (RS) resource or resource set (for example a first uplink positioning reference signal (SRS), or, for example a first downlink positioning reference signal (PRS)), and/or
wherein the second configuration information comprises a second resource (ID) identifier identifying a second reference signal (RS) resource or resource set (for example a second uplink positioning reference signal (SRS), or, for example a second downlink positioning reference signal (PRS)).

24-25. (canceled)

26. The user equipment according to claim 1,
wherein the configuration information (which, for example, comprising a definition of a sequence) comprises information on a validity information (e.g., a validity condition),
wherein the user equipment is configured to determine whether or not the configuration information is currently valid for the user equipment depending on the validity condition.

27. The user equipment according to claim 26,
wherein the validity information comprises information on a validity area,
wherein the user equipment is configured to determine or to receive information on whether or not the user equipment is located within the validity area,
wherein, if the user equipment is located within the validity area, the user equipment is configured to transmit and/or to receive the reference signal for positioning depending on the configuration information during the second radio resource control state of the user equipment, and
wherein, if the user equipment is located outside of the validity area, the user equipment is configured to not transmit and/or to not receive the reference signal for positioning depending on the configuration information during second radio resource control state of the user equipment.

28-70. (canceled)

71. A network entity of a wireless communication system, wherein the network entity is configured
to transmit first configuration information to a user equipment of the wireless communication system, wherein the first configuration information is suitable for configuring the user equipment to transmit and/or to receive a reference signal for positioning during a first radio resource control state and during a second radio resource control state of the user equipment, or
to transmit the first configuration information and second configuration information to the user equipment of the wireless communication system, wherein the first configuration information is suitable for configuring the user equipment to transmit and/or to receive the reference signal for positioning during the first radio resource control state of the user equipment, and wherein the second configuration information is suitable for configuring the user equipment to transmit and/or receive the reference signal for positioning during the second radio resource control state of the user equipment,
and wherein the network entity is configured to transmit the reference signal for positioning to the user equipment, or the network entity is to receive the reference signal for positioning from the user equipment.

72-90. (canceled)

91. A system, comprising:
a user equipment for transmitting and receiving data in a wireless communication system, wherein, at a point-in-time, the user equipment is in one of a plurality of radio resource control (RRC) states,
wherein for each radio resource control state of at least a first radio resource control state and a second radio resource control state of the plurality of radio resource control states, when the user equipment is in said radio resource control state, the user equipment is configured to transmit and/or to receive a reference signal for positioning depending on configuration information received from a network entity of the wireless communication system, and
a network entity according to claim 71,
wherein the network entity is configured to transmit configuration information to the user equipment, wherein the configuration information is suitable to configure the user equipment for transmitting and/or for receiving a reference signal for positioning during the second radio resource control state of the user equipment, and
wherein the user equipment is configured to transmit and/or to receive the reference signal for positioning depending on the configuration information during the second radio resource control state of the user equipment.

92. A method for transmitting and receiving data by a user equipment in a wireless communication system,
wherein, at a point-in-time, the user equipment is in one of a plurality of radio resource control (RRC) states,
wherein for each radio resource control state of at least a first radio resource control state and a second radio resource control state of the plurality of radio resource control states, when the user equipment is in said radio resource control state, the user equipment transmits and/or receives a reference signal for positioning depending on configuration information received from a network entity of the wireless communication system.

93. A method for a wireless communication system, wherein a network entity of the wireless communication system
transmits first configuration information to a user equipment of the wireless communication system, wherein the first configuration information is suitable for configuring the user equipment to transmit and/or to receive a reference signal for positioning during a first radio resource control state and during a second radio resource control state of the user equipment, or
transmits the first configuration information and second configuration information to the user equipment of the wireless communication system, wherein the first configuration information is suitable for configuring the user equipment to transmit and/or to receive the reference signal for positioning during the first radio resource control state of the user equipment, and wherein the second configuration information is suitable for configuring the user equipment to transmit and/or receive the reference signal for positioning during the second radio resource control state of the user equipment,
and wherein the network entity transmits the reference signal for positioning to the user equipment, or the network entity receives the reference signal for positioning from the user equipment.

94. A non-transitory computer-readable medium comprising a computer program for implementing the method of claim 92, when the method is implemented by a computer or signal processor.

95. A non-transitory computer-readable medium comprising a computer program for implementing the method of claim 93, when the method is implemented by a computer or signal processor.
